(19) United States
(12) Patent Application Publication
(10) Pub. No.: US 2012/0188873 A1
(43) Pub. Date: Jul. 26, 2012

(54) COMMUNICATION SYSTEM, COMMUNICATION METHOD, RECEIVING APPARATUS, AND TRANSMITTING APPARATUS

(75) Inventor: Keiichi NAKATSUGAWA, Kawasaki (JP)

(73) Assignee: Fujitsu Limited, Kawasaki (JP)

(21) Appl. No.: 13/332,787

(22) Filed: Dec. 21, 2011

(30) Foreign Application Priority Data
Jan. 20, 2011 (JP) 2011-010296

(51) Int. Cl. H04L 12/56; H04L 12/26

(52) U.S. Cl. 370/231; 370/394; 370/252; 370/253

(57) ABSTRACT

A communication system includes a transmitter that transmits a data flow through a single link or a parallel links, and a receiver that receives packets of the data flow, when the data flow of the received packets is transmitted through the parallel links, the received packets are aligned in order and output, and when the data flow of the received packets is transmitted through the single link, the received packets are output in a received sequence.

### CROSS-REFERENCE TO RELATED APPLICATION

This application is based upon and claims the benefit of priority of the prior Japanese Patent Application No. 2011-010296, filed on Jan. 20, 2011, the entire contents of which are incorporated herein by reference.

### FIELD

The embodiments discussed herein are related to a communication system, a communication method, a receiving apparatus, and a transmitting apparatus.

### BACKGROUND

In order to realize high-speed data transfer in a communication system, link aggregation that provides a high-capacity link by combining a plurality of communication links has been developed. An example of link aggregation is IEEE 802.3ad link aggregation for wired Ethernet links (refer to, for example, IEEE Std 802.3ad-2000, “Amendment to Carrier Sense Multiple Access with Collision Detection (CSMA/CD) Access Method and Physical Layer Specifications-Aggregation of Multiple Link Segments”, Mar. 30, 2000, [online], retrieved from the Internet: <URL:http://voiplab.niu.edu.tw/IEEE/obsolete/802.3/802.3ad-2000.pdf> on Jan. 4, 2011). In IEEE 802.3ad, it is assumed that the transmission speeds of all of the Ethernet links are the same. In addition, the design of IEEE 802.3ad is made so that the sequence of transferred packets remains unchanged in the data flow, the packets are not modified, and the original sequence of the packets is not recovered on the receiver side in order to minimize the delay.

Accordingly, although a plurality of Ethernet links are combined, data is transferred via one of the Ethernet links for each of data flows. Thus, the highest throughput of each of the data flows is limited to the transmission speed of the Ethernet link. In addition, in some cases, the sum of the transmission bandwidths of all of the Ethernet links cannot be efficiently used. In IEEE802.3ad, the data flow is referred to as “Conversation”. For example, the data flow is a group of data packets identified by an input port, source/destination MAC addresses, or the type of higher layer.

For example, when data flows 1 and 2 having transmission speeds of 120 Mbps and 80 Mbps are transferred through links 1 and 2 each having a transmission speed of 100 Mbps, respectively, the data flow 1 is transferred only at a transmission speed of 100 Mbps. The remaining data for a bandwidth of 20 Mbps cannot be switched to the link 2 and, thus, cannot be transferred using the remaining transmission bandwidth of 20 Mbps of the link 2.

In contrast, if the transmission speed of a link varies, a technique for efficiently using the bandwidth of a link by allocating a data flow to a plurality of links has been developed (refer to, for example, Japanese Laid-open Patent Publication Nos. 2007-60494 and 2009-239444). In this technique, by recovering the original sequence of transmitted packets on the receiver side, a correct sequence can be ensured even when the data flow is allocated to a plurality of links.

However, in the above-described techniques, since the original sequence of transmitted packets is recovered, the throughput of packet transmission is disadvantageously decreased depending on the waiting time of a packet. For example, if a packet is lost during transmission, the receiver waits for the lost packet until timeout occurs and, thus, a long delay occurs. In particular, in wireless link aggregation, packet loss easily occurs, as compared with a wired link. Thus, the throughput is significantly decreased as a result of the waiting time of a packet.

Furthermore, in order to keep track of the sequence of transmitted packets, a sequence number is added to each of the transmitted packets on the transmitter side. Therefore, the overhead of each of the packet increases and, thus, the throughput of packet transmission disadvantageously decreases.

### SUMMARY

According to an aspect of an embodiment, a communication system includes a transmitter that transmits a data flow through a single link or a parallel links, a receiver that receives packets of the data flow, when the data flow of the received packets is transmitted through the parallel links, the received packets are aligned in order and output, and when the data flow of the received packets is transmitted through the single link, the received packets are output in a received sequence.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a first block diagram of a communication system according to a first exemplary embodiment.

FIG. 2 is a second block diagram of the communication system according to the first exemplary embodiment.

FIG. 3 illustrates an example of application of a transmitting apparatus and a receiving apparatus according to the first exemplary embodiment.

FIG. 4 illustrates an example of connection between transfer apparatuses illustrated in FIG. 3.

FIG. 5 illustrates an example of a method for the processing performed by the transfer apparatus on a transmitter side according to the first exemplary embodiment.

FIG. 6 illustrates an example of a method for allocating a link.

FIG. 7 illustrates a first example of a method for the processing performed by the transfer apparatus on a receiver side according to the first exemplary embodiment.

FIG. 8 illustrates the first example of a method for the processing performed by the transfer apparatus on a receiver side according to the first exemplary embodiment.

FIG. 9 illustrates a second example of a method for the processing performed by a transfer apparatus on the receiver side according to the first exemplary embodiment.

FIG. 10 illustrates the second example of a method for the processing performed by a transfer apparatus on the receiver side according to the first exemplary embodiment.

FIG. 11 illustrates a third example of a method for the processing performed by a transfer apparatus on the receiver side according to the first exemplary embodiment.

FIG. 12 illustrates a fourth example of a method for the processing performed by a transfer apparatus on the receiver side according to the first exemplary embodiment.

FIG. 13 illustrates a communication system according to a second exemplary embodiment.

FIG. 14 illustrates an example of a method for the processing performed by a transfer apparatus on the transmitter side according to the second exemplary embodiment.

FIG. 15 illustrates another example of a method for the processing performed by the transfer apparatus on the transmitter side according to the second exemplary embodiment.

FIG. 16 illustrates a first example of a method for the processing performed by the transfer apparatus on the receiver side according to the second exemplary embodiment.

FIG. 17 illustrates a second example of a method for the processing performed by the transfer apparatus on the receiver side according to the second exemplary embodiment.

FIG. 18 illustrates the second example of a method for the processing performed by the transfer apparatus on the receiver side according to the second exemplary embodiment.

FIG. 19 illustrates a communication system according to a third exemplary embodiment.

FIG. 20 illustrates an example of application of a transmitting apparatus and a receiving apparatus according to the third exemplary embodiment.

FIG. 21 illustrates an example of a method for the processing performed by an enabling controller according to the third exemplary embodiment.

FIG. 22 illustrates a first example of a communication system to which the transfer apparatus is applied.

FIG. 23 illustrates a second example of the communication system to which the transfer apparatus is applied.

### DESCRIPTION OF EMBODIMENTS

Exemplary embodiments of the disclosed technology are described in detail below with reference to the accompanying drawings.

Communication System

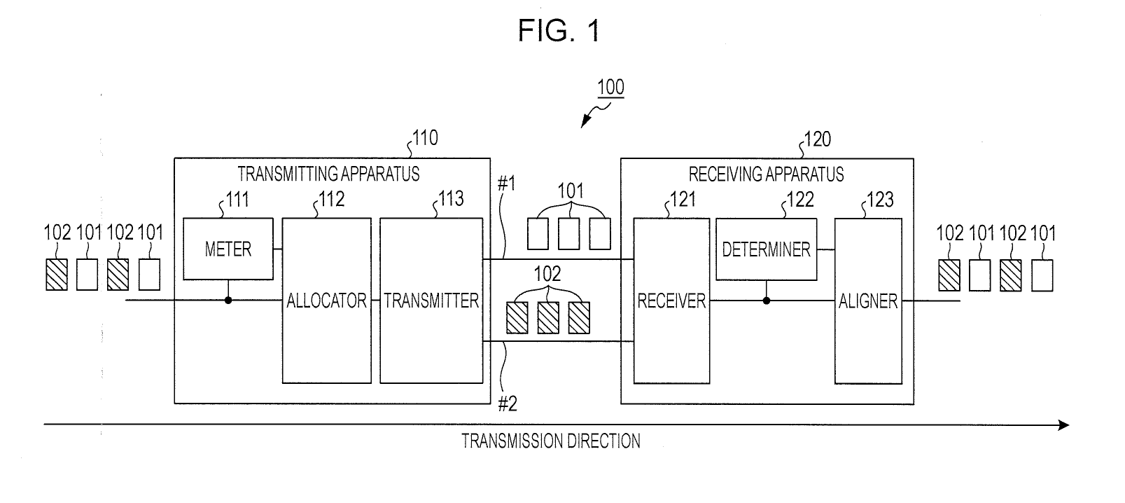

FIG. 1 illustrates a communication system according to a first exemplary embodiment (a first diagram). As illustrated in FIG. 1, according to the first exemplary embodiment, a communication system 100 includes a transmitting apparatus 110 and a receiving apparatus 120. The transmitting apparatus 110 and the receiving apparatus 120 are connected to each other using aggregation links #1 and #2. Note that the transmitting apparatus 110 and the receiving apparatus 120 may be connected to each other using three or more aggregation links. Each of the aggregation links may be a wired link or a wireless link.

The communication system 100 transmits, to the receiving apparatus 120, packets of a data flow input to the transmitting apparatus 110 using aggregation of the aggregation links #1 and #2. In this example, two data flows 1 and 2 are input to the transmitting apparatus 110, and the packets of the data flows 1 and 2 are transmitted using the aggregation links #1 and #2. Packets 101 illustrated in FIG. 1 are packets of the data flow 1, and packets 102 are packets of the data flow 2.

Transmitting Apparatus

The transmitting apparatus 110 transmits the packets of the input data flows 1 and 2 to the receiving apparatus 120 using aggregation of the aggregation links #1 and #2.

More specifically, the transmitting apparatus 110 transmits the packets 101 of the data flow 1 by using one of the aggregation links #1 and #2 or by dividing the packets 101 into two groups (one for the aggregation link #1 and the other for the aggregation link #2). In addition, the transmitting apparatus 110 transmits the packets 102 of the data flow 2 by using one of the aggregation links #1 and #2 or by dividing the packets 102 into two groups (one for the aggregation link #1 and the other for the aggregation link #2).

The transmitting apparatus 110 includes a meter 111, an allocator 112, and a transmitter 113. The meter 111, the allocator 112, and the transmitter 113 may be formed from a circuit. Alternatively, each of the meters 111, the allocator 112, and the transmitter 113 may be formed from one or more digital signal processors (DSPs) and/or one or more field programmable gate arrays (FPGAs).

The meter 111 measures the amount of traffic of the data flows 1 and 2 based on the sizes and points in time at which the packets are input to the transmitting apparatus 110. As used herein, the term “traffic volume” refers to, for example, the data size per unit time. For example, the transmitting apparatus 110 stores the input packets in a buffer, and the meter 111 measures the traffic volume by acquiring the data size of the packets stored in the buffer. In this example, the traffic volume of each of the data flows 1 and 2 is 50 Mbps.

The transmitting apparatus 110 may include an acquirer for acquiring the transmission speed of each of the aggregation links #1 and #2. For example, the transmission speeds of the aggregation links #1 and #2 are stored in a memory of the communication system 100. The acquirer acquires the transmission speeds stored in the memory. Alternatively, the acquirer may monitor the aggregation links #1 and #2 and acquire the transmission speeds of the aggregation links #1 and #2 at predetermined intervals.

In this example, each of the transmission speeds of the aggregation links #1 and #2 is 100 Mbps.

The allocator 112 allocates each of the data flows 1 and 2 to at least one of the aggregation links #1 and #2. For example, the allocator 112 performs the allocation process of the data flows 1 and 2 based on the traffic volumes measured by the meter 111 and the transmission speeds of the aggregation links #1 and #2.

For example, the allocator 112 allocates a data flow to one of the links that has a transmission speed higher than the traffic volume of the data flow. In addition, if the transmission speed of one of the links is insufficient for the traffic volume of a data flow owing to a variation in the traffic volume of the data flow or a variation in each of the links, the allocator 112 allocates the data flow to a plurality of the links.

The transmitter 113 transmits the packets of the data flows 1 and 2 to the receiving apparatus 120 via the aggregation links #1 and #2 based on the result of allocation performed by the allocator 112. In addition, the transmitter 113 adds a sequence number to each of the packets of the data flow allocated to a plurality of the links. However, the transmitter 113 does not add a sequence number to each of the packets of a data flow allocated to a single link. The sequence number serves as sequence information indicating the sequence of the packets.

In the example illustrated in FIG. 1, the allocator 112 allocates the packets 101 of the data flow 1 to only the aggregation link #1 and allocates the packets 102 of the data flow 2 to only the aggregation link #2. In such a case, the packets 101 of the data flow 1 are transmitted through a single aggregation link, and the packets 102 of the data flow 2 are transmitted through a single aggregation link. Accordingly, the sequence of the packets is not changed. In this case, the transmitter 113 does not add a sequence number to each of the packets 101 and 102. Therefore, the overhead of the packets 101 and 102 can be reduced and, thus, the throughput can be increased.

Receiving Apparatus

The receiving apparatus 120 includes a receiver 121, a determiner 122, and an aligner 123. Each of the receiver 121, the determiner 122, and the aligner 123 may be formed from a circuit. Alternatively, each of the receiver 121, the determiner 122, and the aligner 123 may be formed from one or more DSPs and/or one or more FPGAs.

The receiver 121 receives packets transmitted from the transmitting apparatus 110 through the aggregation links #1 and #2. In addition, the receiver 121 identifies the data flow of each of the received packets. For example, the receiver 121 stores each of the received packets in a transmission waiting buffer corresponding to the identified data flow.

The determiner 122 determines whether the data flow of the packet received by the receiver 121 is transmitted through a parallel links or a single link. In this example, the determiner 122 determines whether the data flow of the packet received by the receiver 121 is transmitted through both the aggregation links #1 and #2 or one of the aggregation links #1 and #2.

For example, if the packet has a sequence number, the determiner 122 determines that the data flow is transmitted through both the aggregation links #1 and #2.

However, if the packet does not have a sequence number, the determiner 122 determines that the data flow is transmitted through one of the aggregation links #1 and #2.

In the example illustrated in FIG. 1, the determiner 122 determines that the data flow 1 is transmitted through a single link (the aggregation link #1). In addition, the determiner 122 determines that the data flow 2 is transmitted through a single link (the aggregation link #2).

If the determiner 122 determines that a data flow is transmitted through a parallel links, the aligner 123 recovers the original sequence of the packets received by the receiver 121 using the sequence number included in each of the packets and outputs the packets. For example, the aligner 123 detects disruption of the normal sequence using the sequence numbers and waits for receiving a delayed packet. In this way, the aligner 123 outputs the packets of the data flow in an ascending order of the sequence numbers.

However, if the determiner 122 determines that the data flow is transmitted through a single link, the original sequence of the packets of the data flow remains unchanged. In such a case, the aligner 123 directly outputs the packets received by the receiver 121 without changing the sequence. More specifically, the aligner 123 outputs a received packet without waiting for receiving another packet.

In the example illustrated in FIG. 1, the determiner 122 determines that each of the data flows 1 and 2 is transmitted through a single link. Accordingly, the aligner 123 outputs each of the packets 101 and 102 without recovering the normal sequence. In this way, in a situation in which the sequence of the packets of the data flow remains unchanged, the delay of packet transmission caused by recovering the normal sequence can be prevented. For example, even when a packet is lost in a path between the transmitting apparatus 110 and the receiving apparatus 120, a delay caused by waiting for receipt of the lost packet until timeout occurs can be prevented.

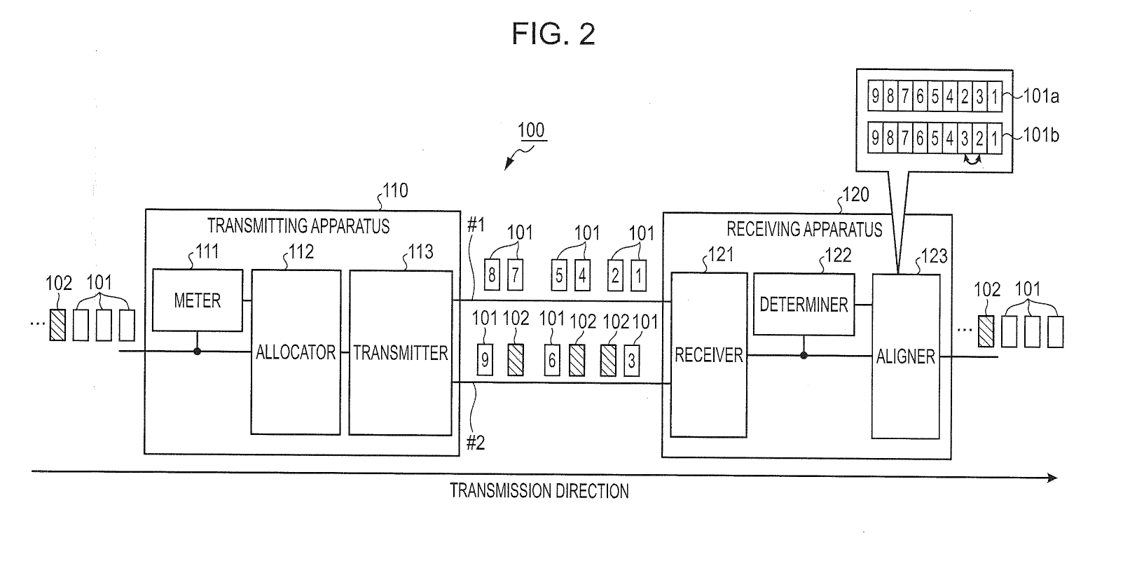

FIG. 2 illustrates the communication system according to the first exemplary embodiment (a second diagram). In FIG. 2, the same reference numerals are used for identical or similar components as used in FIG. 1, and descriptions of the components are not repeated. Unlike FIG. 1, in FIG. 2, the traffic volume of the data flow 1 input to the transmitting apparatus 110 is increased from 50 Mbps to 120 Mbps.

In such a case, the bandwidth of the aggregation link #1 having a transmission speed of 100 Mbps is insufficient for the data flow 1. Thus, the allocator 112 additionally allocates the aggregation link #2 to the data flow 1 as a second link. In such a case, the transmitter 113 adds a sequence number to each of the packets 101 of the data flow 1 and divides the packets 101 into two groups (one for the aggregation link #1 and the other for the aggregation link #2). In this way, the transmitter 113 transmits the packets 101.

In the example illustrated in FIG. 2, the sequence numbers 1 to 9 are assigned to the nine packets 101 of the data flow 1 transmitted from the transmitting apparatus 110 to the receiving apparatus 120.

The packets 101 having the sequence numbers 1, 2, 4, 5, 7, and 8 are allocated to the aggregation link #1. In contrast, the packets 101 having the sequence numbers 3, 6, and 9 are allocated to the aggregation link #2.

As in the example illustrated in FIG. 1, the packets 102 of the data flow 2 are transmitted through only the aggregation link #2. Accordingly, the packets 102 of the data flow 2 do not have the sequence numbers assigned thereto.

The determiner 122 of the receiving apparatus 120 determines that the packets 101 having the sequence numbers assigned thereto among the packets received by the receiver 121 have been transmitted through a parallel links. Accordingly, the aligner 123 recovers the normal sequence of the packets 101 using the sequence numbers assigned to the packets 101.

A packet sequence 101a illustrated in FIG. 2 indicates the packets 101 received by the receiver 121 through the aggregation links #1 and #2. In this example, one of the packets 101 that has the sequence number “3” and that was transmitted through the aggregation link #2 arrives at the receiver 121 earlier than one of the packets 101 that has the sequence number “2” and that was transmitted through the aggregation link #1. Therefore, the sequence is disrupted.

In such a case, the aligner 123 receives the packet 101 having the sequence number “1” and, subsequently, receives the packet 101 having the sequence number “3”. Accordingly, the aligner 123 stores the packet 101 having the sequence number “3” in a buffer and waits for receiving the packet 101 having the sequence number “2”. Upon receiving the packet 101 having the sequence number “2”, the aligner 123 outputs the packet having the sequence number “2” and, subsequently, outputs the packets having the sequence number “3”.

In this way, the normal sequence of the packets 101 can be recovered in accordance with an ascending order of the sequence numbers. A packet sequence 101b indicates the packets 101 arranged in the normal sequence recovered by the aligner 123. In addition, after recovering the normal sequence, the aligner 123 may delete the sequence number portions of the packets 101 in order to change each of the packets 101 to the original format and may output the packet 101.

Note that in the example illustrated in FIG. 2, the transmission speed of the aggregation link #1 remains unchanged while the traffic volume of the data flow 1 is increased. In contrast, for example, when the traffic volume of the data flow 1 remains unchanged and if the transmission speed of the aggregation link #1 is decreased to 40 Mbps, the packets 101 of the data flow 1 may be divided into two groups, which are allocated to the aggregation links #1 and #2. That is, it can be determined whether a packet allocation operation illustrated in FIG. 2 is performed or not based on the magnitude relationship between the traffic volumes of the data flows and the transmission speeds of the aggregation links.

For example, if the packet serves as an Ethernet (IEEE802.3) frame, the sequence number can be defined as one of the option headers inserted immediately after a destination MAC address field at the top of the frame header or a source MAC address field. However, a technique for adding the sequence number is not limited thereto. Any technique can be employed.

Example of Application of Transmitting Apparatus and Receiving Apparatus

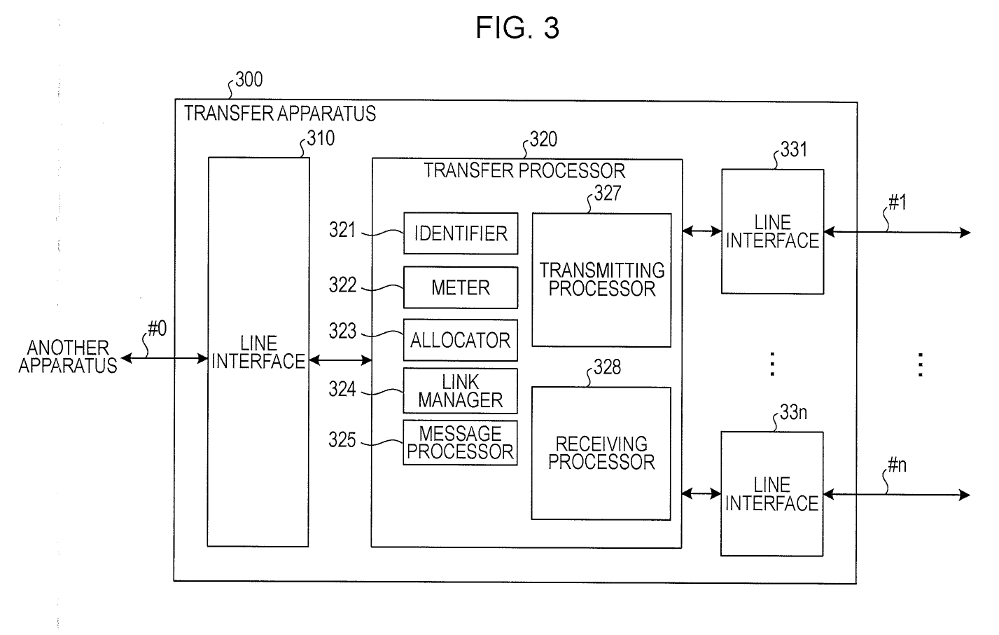

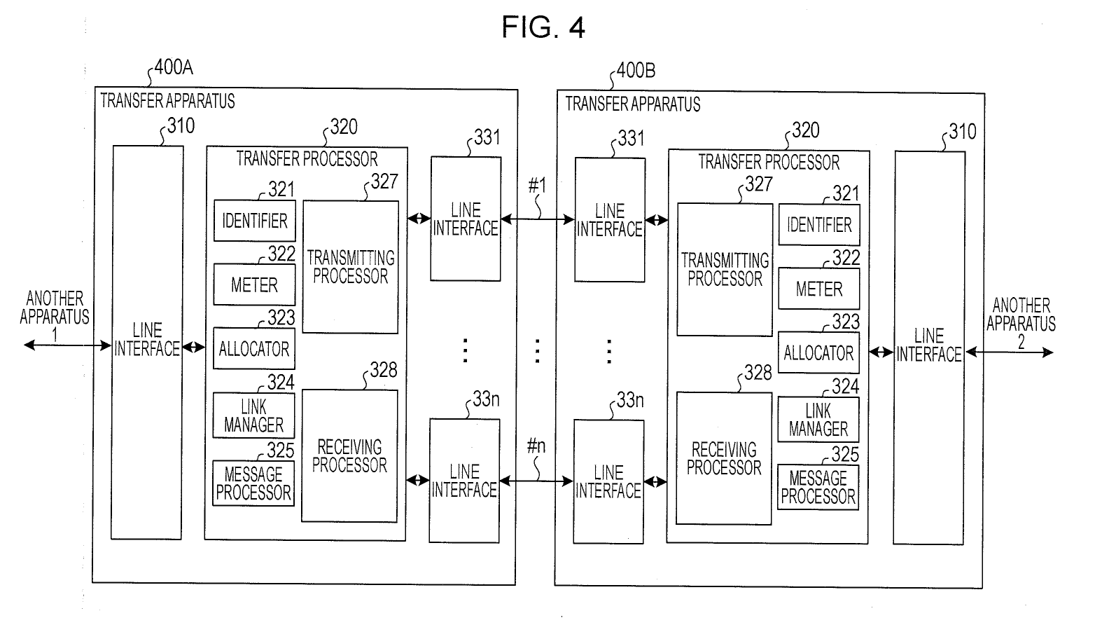

FIG. 3 illustrates an example of application of the transmitting apparatus and the receiving apparatus according to the first exemplary embodiment. As illustrated in FIG. 3, a transfer apparatus 300 includes the transmitting apparatus 110 and the receiving apparatus 120 illustrated in FIGS. 1 and 2. The transfer apparatus 300 is connected to another apparatus, such as a radio base station or a server, using a link #0. In addition, the transfer apparatus 300 is connected to a transfer apparatus serving as a communication partner through n aggregation links #1 to #n (n≧2) (refer to, for example, FIG. 4). Each of the link #0 and the aggregation links #1 to #n may be a wired link or a wireless link.

The transfer apparatus 300 includes a line interface 310, a transfer processor 320, and line interfaces 331 to 33n. The line interface 310 is a communication interface containing the link #0. If the link #0 is a wireless link, the line interface 310 further includes an antenna. In addition, the line interface 310 may be separated from the transfer processor 320 in the physical configuration of the apparatus, and the number of the line interfaces 310 may be increased with an increase in the number of links used. Each of the line interface 310, the transfer processor 320, and the line interfaces 331 to 33n may be formed from a circuit. Alternatively, each of the line interface 310, the transfer processor 320, and the line interfaces 331 to 33n may be formed from one or more DSPs and/or one or more FPGAs. The line interfaces 331 to 33n are communication interfaces containing the aggregation link #1 to #n, respectively. If the aggregation links #1 to #n are wireless links, each of the line interfaces 331 to 33n further includes an antenna. In addition, the line interfaces 331 to 33n may be separated from the transfer processor 320 in the physical configuration of the apparatus, and the number of the line interfaces 331 to 33n may be increased with an increase in the number of aggregation links used.

For example, the transfer processor 320 can be formed from one or more DSPs and FPGAs. The transfer processor 320 includes an identifier 321, a meter 322, an allocator 323, a link manager 324, a message processor 325, a transmitting processor 327, and a receiving processor 328.

The identifier 321 identifies the data flow of a packet received from another apparatus through the link #0 and the line interface 310. Identification of a data flow can be performed by, for example, using the input link (the input port) of the line interface 310 to which the packet is input, the destination or source MAC address, the destination or source IP address, the destination or source port number, or an identifier indicating the type of other data.

The meter 322 measures the input traffic volume using the size of the packets of the data flow identified by the identifier 321. As used herein, the term “traffic volume” refers to, for example, the data size per unit time. For example, the transfer apparatus 300 stores, in a transmission waiting buffer, the packets received through the link #0 and the line interface 310. The meter 322 measures the traffic volume by acquiring the data size of the packets stored in the transmission waiting buffer.

The allocator 323 allocates at least one of the aggregation links to the data flow using the traffic volume of the data flow measured by the meter 322 and the transmission speeds of the aggregation links #1 to #n acquired by the link manager 324.

The link manager 324 acquires the transmission speeds of the aggregation links #1 to #n and manages the aggregation links #1 to #n. Note that if the transmission speeds of the aggregation links #1 to #n are fixed, the transmission speeds of the aggregation links #1 to #n are stored in a memory of the transmitting apparatus 110. The link manager 324 refers to the transmission speeds stored in the memory in order to acquire the transmission speeds.

The transmission speeds of the aggregation links #1 to #n are determined by the line interfaces 331 to 33n based on the quality information regarding each of the aggregation links #1 to #n. For example, the link manager 324 acquires the transmission speeds of the aggregation links #1 to #n from the line interfaces 331 to 33n via the receiving processor 328.

For example, if the aggregation links #1 to #n are wireless links, the line interfaces 331 to 33n acquire the quality information regarding the wireless channels measured by the communication interface of a transmitting apparatus serving as the communication partner of the transfer apparatus 300 through feedback. Subsequently, each of the line interfaces 331 to 33n selects one of the modulation methods based on the acquired quality information and sends, to the link manager 324, a message indicating the transmission speed corresponding to the selected modulation method.

Examples of the quality information include the received signal strength indicator (RSSI), the signal to noise ratio (SNR), and the signal-to-interference and noise ratio (SINR). Alternatively, the link manager 324 may acquire, via the line interfaces 331 to 33n and the receiving processor 328, the quality information regarding the wireless channels fed back from the transmitting apparatus serving as a communication partner. Thereafter, the link manager 324 selects one of the modulation methods using the acquired quality information and acquires the transmission speed corresponding to the selected modulation method. In addition, the link manager 324 sends a message indicating the selected modulation method to each of the line interfaces 331 to 33n. The line interfaces 331 to 33n communicate with the transmitting apparatus serving as the communication partner using the modulation method notified by the link manager 324.

The message processor 325 receives and transmits a control message (control information) from and to the transmitting apparatus that is a communication partner via, for example, the line interfaces 331 to 33n based on the result of allocation performed by the allocator 323. The control message indicates whether the transmitting processor 327 transmits the data flow through a single link or a parallel links. Note that if a control message is not communicated, the message processor 325 may be removed from the configuration.

The transmitting processor 327 allocates each of the packets stored in the transmission waiting buffer to one of the line interfaces 331 to 33n using the result of allocation performed by the allocator 323 and transmits the packet to the transmitting apparatus that is a communication partner. In addition, the transmitting processor 327 adds a sequence number to a packet of the data flow that is allocated to a parallel links by the allocator 323.

The receiving processor 328 receives the packets transmitted from the transmitting apparatus that is a communication partner through the aggregation links #1 to #n and the line interfaces 331 to 33n. In addition, the receiving processor 328 determines whether the received packets have sequence numbers and recovers the normal sequence of the packets based on the sequence numbers.

FIG. 4 illustrates an example of connection between the transfer apparatuses illustrated in FIG. 3. In FIG. 4, the same reference numerals are used for identical or similar components as used in FIG. 3, and descriptions of the components are not repeated. Each of transfer apparatuses 400A and 4006 illustrated in FIG. 4 has a configuration that is the same as the configuration of the transfer apparatus 300 illustrated in FIG. 3.

The transfer apparatuses 400A and 400B are connected to each other via the aggregation links #1 to #n. In this example, the transfer apparatus 400A is located on the transmitter side of the link aggregation. In contrast, the transfer apparatus 400B is located on the receiver side of the link aggregation.

For example, a packet transmitted from an apparatus 1 connected to the transfer apparatus 400A is received by the line interface 310 of the transfer apparatus 400A. The packet received by the line interface 310 of the transfer apparatus 400A is transmitted to the transfer apparatus 400B via the transfer processor 320 of the transfer apparatus 400A, the line interfaces 331 to 33n, and one of the aggregation links #1 to #n. The packets transmitted to the transfer apparatus 400B are received by the line interfaces 331 to 33n of the transfer apparatus 400B. Thereafter, the packets pass through the transfer processor 320 and the line interface 310 of the transfer apparatus 400B. Subsequently, the packets are transmitted to an apparatus 2 connected to the transfer apparatus 400B.

The meter 111 illustrated in FIG. 1 can be formed from, for example, the meter 322 of the transfer apparatus 400A. The allocator 112 illustrated in FIG. 1 can be formed from, for example, the allocator 323 of the transfer apparatus 400A. The transmitter 113 illustrated in FIG. 1 can be formed from, for example, the transmitting processor 327 and the line interfaces 331 to 33n of the transfer apparatus 400A. The receiver 121 illustrated in FIG. 1 can be formed from the line interfaces 331 to 33n and the receiving processor 328 of the transfer apparatus 400B. The determiner 122 and the aligner 123 illustrated in FIG. 1 can be formed from the receiving processor 328 of the transfer apparatus 400B.

In the following description, if a data flow is transmitted through a single link, the link allocated to the data flow is referred to as a “first link”. In addition, if a data flow is transmitted through a parallel links, a link allocated to the data flow other than the first link is referred to as a “second link”.

If three or more aggregation links are used (i.e., if n 3), two or more links may be allocated as the second link. For example, if three aggregation links are used, one of the three aggregation links may be allocated as a first link, and the other two aggregation links may be allocated as a second link. In such a case, the packets of the data flow are divided into groups corresponding to all of the three aggregation links.

Processing Performed by Transfer Apparatus on Transmitter Side

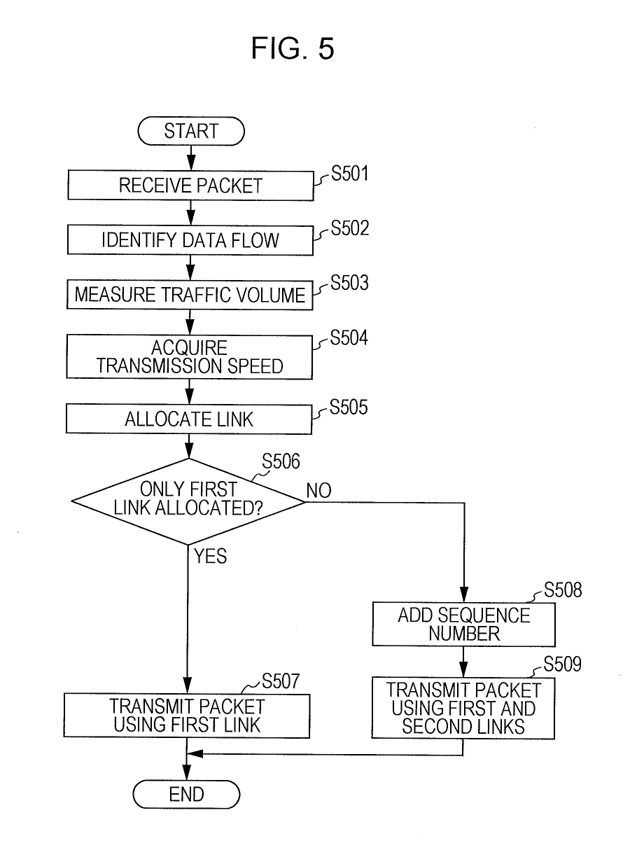

FIG. 5 illustrates an example of a method for the processing performed by the transfer apparatus on the transmitter side according to the first exemplary embodiment. This processing is performed by, for example, one or more DSPs and/or one or more FPGAs included in the transmitting apparatus. For example, the transfer apparatus 400A on the transmitter side repeatedly performs the following operations. That is, the line interface 310 receives a packet from a different apparatus 1 first (operation S501). Thereafter, the identifier 321 identifies the data flow of the packet received in operation S501 (operation S502).

Subsequently, the meter 322 measures the traffic volume of the data flow identified in operation S502 using the size of each of the packets and the arrival intervals (operation S503). Thereafter, the link manager 324 acquires the transmission speed of each of the aggregation links #1 to #n (operation S504).

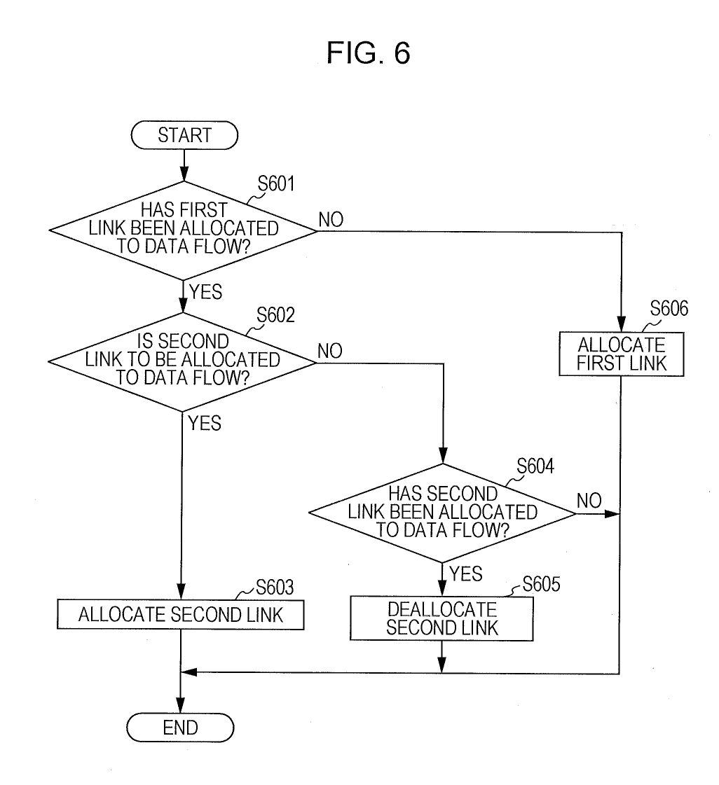

Subsequently, the allocator 323 allocates a link to the data flow identified in operation S502 (operation S505). More specifically, the allocator 323 allocates a link based on the traffic volume measured in operation S503 and the transmission speeds acquired in operation S504. The allocation of a link performed in operation S505 is described in more detail below (refer to, for example, FIG. 6).

Subsequently, the transmitting processor 327 determines whether only the first link is allocated to the data flow as a result of the allocation performed in operation S505 (operation S506). If only the first link is allocated to the data flow (“Yes” in operation S506), the transmitting processor 327 transmits the packets of the data flow to the transfer apparatus 400B using the first link (operation S507). Thereafter, the series of processes is completed.

If, in operation S506, the first link and the second link are allocated to the data flow (“No” in operation S506), the transmitting processor 327 adds a sequence number to each of the packets of the data flow (operation S508). Thereafter, the transmitting processor 327 transmits the packets having the sequence numbers added thereto in operation S508 to the transfer apparatus 400B using the first link and the second link allocated to the data flow (operation S509). Thereafter, the series of processes is completed.

While the above description has been made with reference to the process that is executed each time a packet is received (operations S504 and S505), acquisition of the transmission speed of a link and allocation of a link may be performed, for example, at predetermined intervals.

FIG. 6 illustrates an example of a method for allocating a link. For example, as illustrated in FIG. 5, in operation S505, the allocator 323 performs the following processing. The allocator 323 determines whether the first link has already been allocated to the data flow which is a target of allocation (operation S601).

If the first link has already been allocated to the data flow (“Yes” in operation S601), the allocator 323 determines whether the second link is allocated to the target data flow in addition to the first link (operation S602). In operation S602, the allocator 323 makes the determination based on the traffic volume of the data flow measured in operation S503 illustrated in FIG. 5 and the transmission speed of each of the links acquired in operation S504 illustrated in FIG. 5.

For example, if a value obtained by subtracting the total traffic volume allocated to the first link from the transmission speed of the first link (i.e., an available bandwidth of the first link) is greater than a threshold value, the allocator 323 determines that the second link is not allocated to the target data flow. However, if the value obtained by subtracting the total traffic volume allocated to the first link from the transmission speed of the first link (i.e., the available bandwidth of the first link) is less than or equal to the threshold value, the allocator 323 determines that the second link is allocated to the target data flow.

Alternatively, if a value obtained by dividing the total traffic volume allocated to the first link by the transmission speed of the first link (i.e., the usage ratio of the first link) is less than a threshold value, the allocator 323 determines that the second link is not allocated to the target data flow. However, if the value obtained by dividing the total traffic volume allocated to the first link by the transmission speed of the first link (i.e., the usage ratio of the first link) is greater than or equal to the threshold value, the allocator 323 determines that the second link is allocated to the target data flow.

If, in operation S602, it is determined that the second link is further allocated (“Yes” in operation S602), the allocator 323 allocates the second link other than the first link from among the parallel links (operation S603). Thereafter, the series of processes is completed. At that time, the message processor 325 may send, to the transfer apparatus 400B, a control message indicating that the second link has been allocated. The control message may include information for identifying the data flow.

In operation S603, for example, the allocator 323 allocates the link having the widest available bandwidth (=transmission speed−total traffic volume) other than the first link. Alternatively, the allocator 323 may allocate the link having the lowest usage ratio (=total traffic volume/transmission speed) other than the first link. Still alternatively, the allocator 323 may allocate, as a second link, the link having the highest transmission speed other than the first link or the link having a transmission speed that is the same as or the closest to the transmission speed of the first link.

However, if, in operation S602, it is determined that the second link is not further allocated (“No” in operation S602), the allocator 323 determines whether the second link has already been allocated to the target data flow (operation S604). If the second link has not yet been allocated (“No” in operation S604), the allocator 323 completes the series of processes without allocating a new link to the target data flow.

In contrast, if, in operation S604, the second link has already been allocated (“Yes” in operation S604), the allocator 323 deallocates the second link from the target data flow (operation S605). Thereafter, the series of processes is completed. In this way, the packets of the target data flow are transmitted through only the first link. At that time, the message processor 325 may send, to the transfer apparatus 400B, a control message indicating that the second link has been deallocated. The control message may include information for identifying the data flow.

However, if, in operation S601, the first link has not yet been allocated to the data flow (“No” in operation S601), the allocator 323 allocates the first link to the target data flow (operation S606). Thereafter, the series of processes is completed. In operation S606, for example, the allocator 323 allocates, as the first link, the link having the widest available bandwidth (=transmission speed−total traffic volume). Alternatively, the allocator 323 may allocate the link having the lowest usage ratio (=total traffic volume/transmission speed) as the first link. Still alternatively, the allocator 323 may allocate, as the first link, the link having the highest transmission speed.

Processing Performed by Transfer Apparatus on Receiver Side

Example 1 of Processing Performed by Transfer Apparatus on Receiver Side

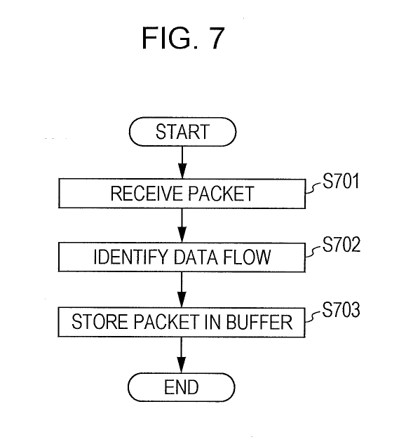

FIG. 7 illustrates a first example of a method for the processing performed by a transfer apparatus on the receiver side according to the first exemplary embodiment. This processing is performed by, for example, one or more DSPs and/or one or more FPGAs included in the transmitting apparatus. For example, the transfer apparatus 400B on the transmitter side repeatedly performs the following operations. That is, one of the line interfaces 331 to 33n receives a packet from the transfer apparatus 400A on the transmitter side through one of the aggregation links #1 to #n first (operation S701). Thereafter, the receiving processor 328 identifies the data flow of the packet received in operation S701 (operation S702). The data flow of the packet can be identified by using, for example, the header information of the packet.

Subsequently, the receiving processor 328 stores the packet received in operation S701 in a buffer corresponding to the data flow identified in operation S702 (operation S703). Thereafter, the series of processes is completed. In addition, the receiving processor 328 may update the management information regarding buffers included in the transfer apparatus 400B when storing the packet in the buffer.

The buffer management information is used for managing transmission waiting packets in the form of, for example, a queue for each of the data flows. The buffer management information indicates the presence/absence of a transmission waiting packet and the position of a packet stored in the buffer.

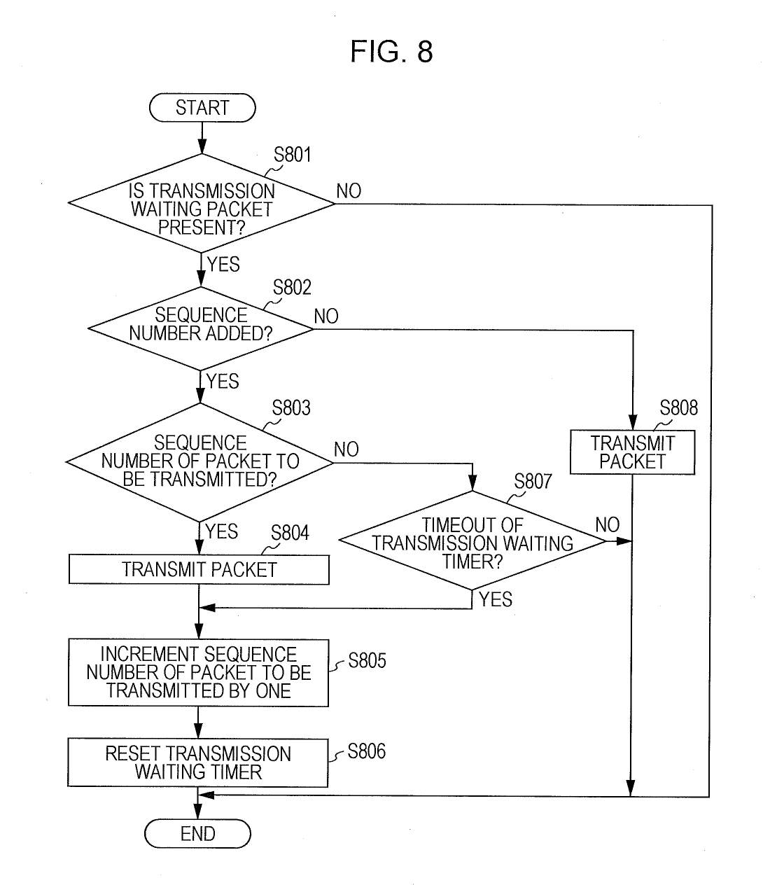

The method for the processing performed by the transfer apparatus on the receiver side according to the first exemplary embodiment is further described with reference to FIG. 8. The transmitting processor 327 of the transfer apparatus 400B on the receiver side periodically acquires the state of the queue of the transmission waiting packets of each of the data flows based on the buffer management information held in the transfer apparatus 400B. Thereafter, the transmitting processor 327 performs the operations described below on each of the data flows.

The transmitting processor 327 determines whether a transmission waiting packet to be transmitted to a different apparatus 2 is present in the buffer corresponding to the target data flow (operation S801). If a transmission waiting packet is not present in the buffer (“No” in operation S801), the transmitting processor 327 completes the series of processes. However, if a transmission waiting packet is present in the buffer (“Yes” in operation S801), the transmitting processor 327 determines whether the transmission waiting packet has a sequence number added thereto (operation S802).

If, in operation S802, the transmission waiting packet has a sequence number added thereto (“Yes” in operation S802), the transmitting processor 327 determines whether the sequence number of the transmission waiting packet is the sequence number of a packet to be subsequently transmitted (operation S803). For example, if the sequence number of the packet previously transmitted is “0”, the sequence number of a packet to be subsequently transmitted is “1”. If the sequence number of the transmission waiting packet is “1”, the transmitting processor 327 determines that the sequence number is a sequence number for a transmission waiting packet. However, if the sequence number of the transmission waiting packet is a number other than “1”, the transmitting processor 327 determines that the sequence number is not a sequence number for a transmission waiting packet.

If, in operation S803, the sequence number of the transmission waiting packet is the sequence number for a packet to be subsequently transmitted (“Yes” in operation S803), the transmitting processor 327 transmits the transmission waiting packet (operation S804). Thereafter, the transmitting processor 327 increments the sequence number for a packet to be subsequently transmitted by one (operation S805). For example, after the transmitting processor 327 transmits a packet having the sequence number “1”, the transmitting processor 327 sets the sequence number for a packet to be subsequently transmitted to “2”. Subsequently, the transmitting processor 327 resets a transmission waiting timer for managing the waiting time used for recovering the normal sequence of the packets (operation S806). Thereafter, the series of processes is complete.

However, if, in operation S803, the sequence number of the transmission waiting packet is not the sequence number for a packet to be subsequently transmitted (“No” in operation S803), the transmitting processor 327 determines whether the timeout of the transmission waiting timer has occurred (operation S807). For example, the timeout value of the transmission waiting timer may be preset in the transfer apparatus 400B.

If, in operation S807, the timeout of the transmission waiting timer has occurred (“Yes” in operation S807), it can be determined that the packet having a sequence number equal to the sequence number for a packet to be subsequently transmitted is lost during transmission owing to, for example, some error. In such a case, the processing performed by the transmitting processor 327 proceeds to operation S805. In this way, the sequence number for a packet to be subsequently transmitted can be incremented and skipped.

However, if, in operation S807, the timeout of the transmission waiting timer has not occurred (“No” in operation S807), the transmitting processor 327 completes the series of processes. In this way, the transmitting processor 327 can wait for receiving the packet having a sequence number equal to the sequence number for a packet to be subsequently transmitted until the timeout of the transmission waiting timer occurs.

If, in operation S802, the transmission waiting packet has no sequence number added thereto (“No” in operation S802), the transmitting processor 327 can determine that the data flow of the transmission waiting packet is transmitted through a single link. Accordingly, in such a case, it can be determined that the normal sequence of the packets is maintained during transmission from the transfer apparatus 400A to the transfer apparatus 400B. At that time, the transmitting processor 327 directly transmits the transmission waiting packet without recovering the original sequence (operation S808). Thereafter, the series of processes is completed.

Example 2 of Processing Performed by Transfer Apparatus on Receiver Side

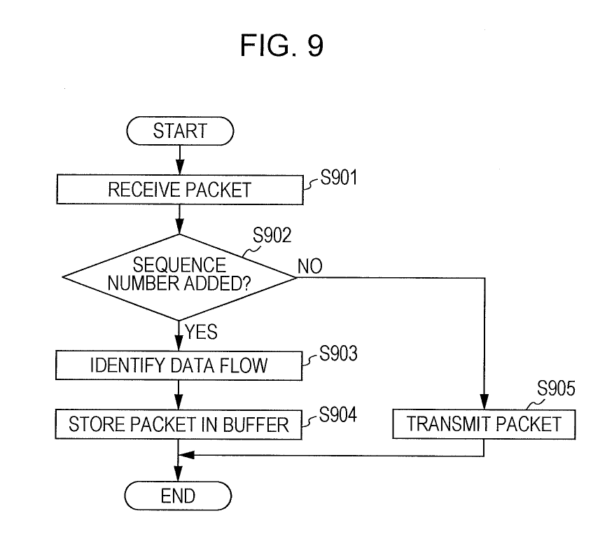

FIG. 9 illustrates a second example of a method for the processing performed by a transfer apparatus on the receiver side according to the first exemplary embodiment. For example, the transfer apparatus 400B on the receiver side may repeatedly perform the operations described below. The line interface 310 receives a packet from the transfer apparatus 400A on the transmitter side through one of the line interfaces 331 to 33n (operation S901) first. Subsequently, the receiving processor 328 determines whether the packet received in operation S901 has a sequence number added thereto (operation S902).

If, in operation S902, the packet has a sequence number added thereto (“Yes” in operation S902), the receiving processor 328 identifies the data flow of the packet received in operation S901 (operation S903). Subsequently, the receiving processor 328 stores the packet received in operation S901 in a buffer corresponding to the data flow identified in operation S903 (operation S904). Thereafter, the series of processes is completed.

However, if, in operation S902, the packet has no sequence number added thereto (“No” in operation S902), it can be determined that the data flow of the received packet is transmitted through a single link. Accordingly, in such a case, it can be determined that the normal sequence of the packets is maintained during transmission from the transfer apparatus 400A to the transfer apparatus 400B. At that time, the transmitting processor 327 directly transmits the received packets without recovering the original sequence (operation S905). Thereafter, the series of processes is completed. As mentioned above, if the data flow of the received packets is transmitted through a single link, the packets may be output without performing identification of the data flow and without recovering the original sequence.

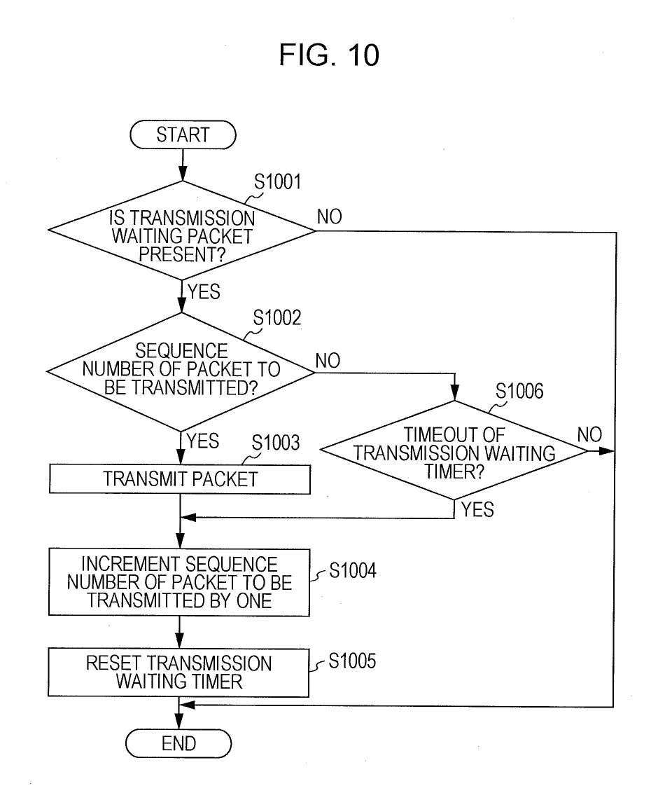

The second example of a method for the processing performed by the transfer apparatus on the receiver side according to the first exemplary embodiment is further described with reference to FIG. 10. When the transfer apparatus 400B performs the processing illustrated in FIG. 9, the following operations, for example, may be performed on each of the data flows. The transmitting processor 327 determines whether a transmission waiting packet is present in the buffer corresponding to the target data flow (operation S1001). If a transmission waiting packet is not present in the buffer (“No” in operation S1001), the transfer apparatus 400B completes the series of processes.

However, if, in operation S1001, a transmission waiting packet is present for the target data flow (“Yes” in operation S1001), the processing performed by the transfer apparatus 400B proceeds to operation S1002. Operations S1002 to S1006 are the same as operations S803 to S807 illustrated in FIG. 8, respectively. That is, when the processing illustrated in FIG. 9 is performed, each of the packets stored in the buffer has a sequence number added thereto. Accordingly, the transfer apparatus 4006 recovers the original sequence of the packets stored in the buffer.

As illustrated in FIGS. 9 and 10, the transfer apparatus 400B determines whether the received packets have sequence numbers added thereto first. If the received packets have sequence numbers added thereto, the transfer apparatus 400B identifies the data flow and recovers the original sequence of the packets. However, if the received packets have no sequence number added thereto, the transfer apparatus 400B directly transmits the received packets.

Example 3 of Processing Performed by Transfer Apparatus on Receiver Side

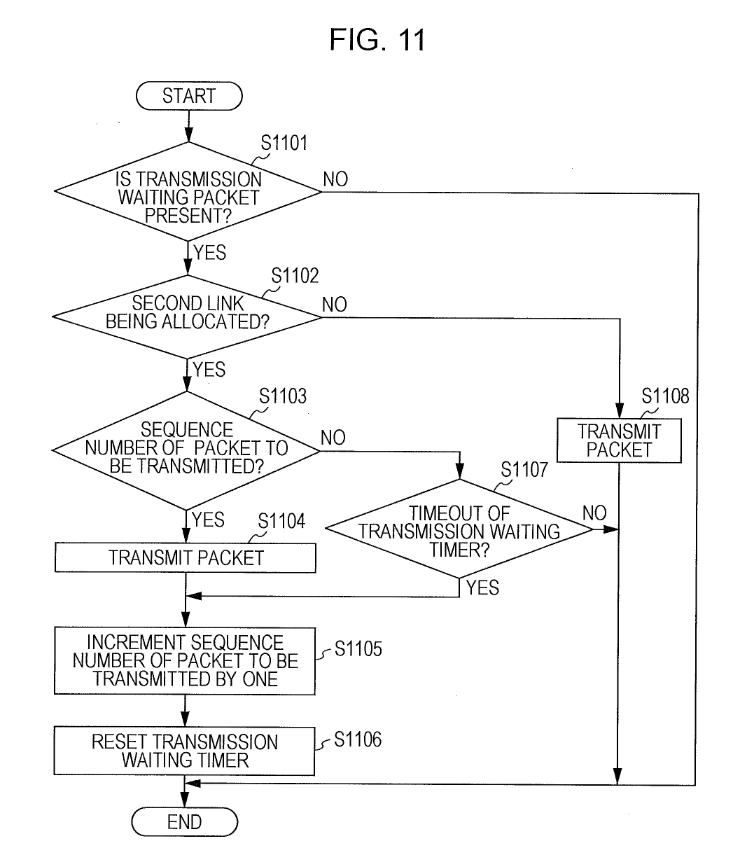

FIG. 11 illustrates a third example of a method for the processing performed by a transfer apparatus on the receiver side according to the first exemplary embodiment. For example, the transmitting processor 327 of the transfer apparatus 400B on the receiver side may perform a process illustrated in FIG. 11 in addition to the process illustrated in FIG. 7. The transfer apparatus 400B may be formed from a circuit. Alternatively, the transfer apparatus 400B may be formed from one or more DSPs and/or one or more FPGAs. Operations S1101 to S1108 illustrated in FIG. 11 are the same as operations S801 to S808 illustrated in FIG. 8, respectively.

However, in operation S1102, the transmitting processor 327 determines whether the transfer apparatus 400A has allocated the second link to the target data flow (operation S1102). More specifically, the transmitting processor 327 determines whether the transfer apparatus 400A has allocated the second link to the target data flow based on a control message received from the transfer apparatus 400A by the message processor 325.

If, in operation S1102, the transfer apparatus 400A has not allocated the second link to the target data flow (“No” in operation S1102), the processing performed by the transfer apparatus 400B proceeds to operation S1108. However, if the transfer apparatus 400A has allocated the second link to the target data flow (“Yes” in operation S1102), the processing performed by the transfer apparatus 400B proceeds to operation S1103. In this way, whether the data flow is transmitted through a parallel links or a single link may be determined based on a control message received from the transfer apparatus 400A.

Example 4 of Processing Performed by Transfer Apparatus on Receiver Side

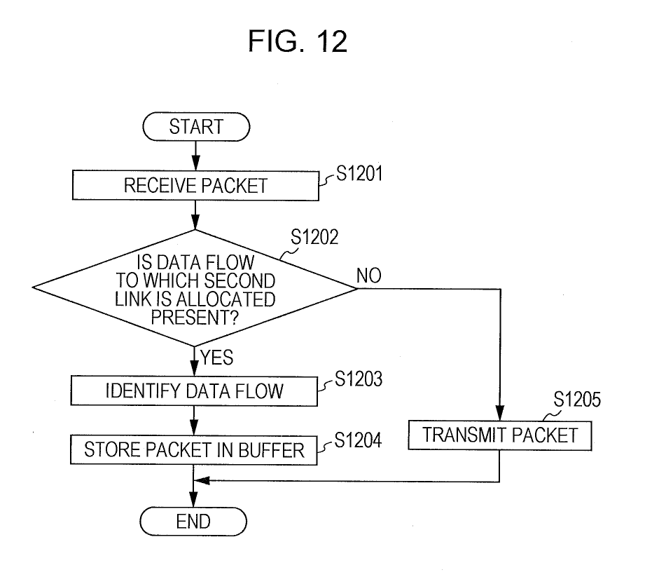

FIG. 12 illustrates a fourth example of a method for the processing performed by a transfer apparatus on the receiver side according to the first exemplary embodiment. For example, the transmitting processor 327 of the transfer apparatus 400B on the receiver side may perform the operations described below. Operations S1201 to S1205 illustrated in FIG. 12 are the same as operations S901 to S905 illustrated in FIG. 9, respectively.

However, in operation S1202, the transmitting processor 327 determines whether a data flow to which the second link is allocated is present based on a control message received from the transfer apparatus 400A by the message processor 325 (operation S1202). If a data flow to which the second link is allocated is not present (“No” in operation S1202), the processing performed by the transmitting processor 327 proceeds to operation S1205. However, if a data flow to which the second link is allocated is present (“Yes” in operation S1202), the processing performed by the transmitting processor 327 proceeds to operation S1205. In addition, the transfer apparatus 400B performs, for example, the process illustrated in FIG. 10 in addition to the process illustrated in FIG. 12.

As described above, if the transfer apparatus 400B has received, from the transfer apparatus 400A that is a communication partner, a message indicating that the second link is allocated to any one of the data flows, the transfer apparatus 400B may identify the data flow and recover the original sequence of packets. However, if the second link is not allocated to any one of the data flows, the transfer apparatus 400B directly transmits the packet.

In addition, upon receipt of a control message from the transfer apparatus 400A, the transfer apparatus 400B may return a response message to the transfer apparatus 400A. Upon receipt of the response message sent from the transfer apparatus 400B, the transfer apparatus 400A may start dividing the packets of the data flow into groups for the first and second links.

As described above, in the communication system 100 according to the first exemplary embodiment, the transmitting apparatus 110 transmits a data flow through a single link or a parallel links. In addition, if the data flow is transmitted through a parallel links, the receiving apparatus 120 recovers the original sequence of the packets of the received data flow. However, if the data flow is transmitted through a single link, the receiving apparatus 120 does not recover the original sequence of the packets of the received data flow. In this way, a delay time caused by a recovery operation of the original sequence of the packets can be reduced and, thus, the throughput of packet transmission can be increased.

In particular, if the aggregation link is a wireless link, packet loss easily occurs. Therefore, a delay time caused by a recovery operation of the original sequence of the packets increases. In contrast, the communication system 100 can reduce a delay time caused by a recovery operation of the original sequence of the packets and, thus, increase the throughput of packet transmission. In addition, if a data flow is transmitted through a single link, the original sequence of the packets can be preserved. Therefore, the quality of communication can be maintained without performing a recovery operation of the original sequence of the packets.

In addition, when transmitting a data flow through a parallel links, the transmitting apparatus 110 adds a sequence number (sequence information) to each of the packets of the data flow. In contrast, when transmitting a data flow through a single link, the transmitting apparatus 110 does not add a sequence number to each of the packets. In this way, the overhead of each of the packets decreases and, thus, the throughput of packet transmission increases. Furthermore, when a data flow is transmitted through a single link, the original sequence of the packets is preserved. Accordingly, the quality of communication can be maintained without adding a sequence number to each of the packets.

In such a case, the receiving apparatus 120 can determine whether the data flow is transmitted through a parallel links or a single link by determining whether the received packet has a sequence number added thereto. Accordingly, the receiving apparatus 120 can determine whether the data flow is transmitted through a parallel links or a single link without using flag information or control information indicating whether the data flow is transmitted through a parallel links or a single link.

Alternatively, the transmitting apparatus 110 may transmit, to the receiving apparatus 120, a control message (control information) indicating whether the data flow is to be transmitted through a parallel links or a single link. In such a case, the receiving apparatus 120 can determine whether the data flow is transmitted through a parallel links or a single link based on the control message transmitted from the transmitting apparatus 110.

In addition, the transmitting apparatus 110 measures the traffic volume of the data flow and allocates the data flow to at least one of the links between the transmitting apparatus 110 and the receiving apparatus 120 based on the measured traffic volume. In this way, the transmitting apparatus 110 can transmit the data flow through a single link or a parallel links in accordance with the traffic volume of the data flow to be transmitted. Thus, the bandwidth of each of the links can be efficiently used.

Furthermore, the transmitting apparatus 110 acquires the transmission speed of each of the links and allocates the data flow to at least one of the links based on the acquired transmission speeds of the links and the traffic volume of the data flow. Thereafter, the transmitting apparatus 110 transmits the data flow. In this way, in a communication system in which each of the links is a wireless link and the transmission speed of the link varies, if the bandwidth of one of the links is insufficient for the required bandwidth, the data flow is transmitted through a plurality of the links. Thus, the bandwidth of each of the links can be efficiently used. However, if the bandwidth of one of the links is sufficient for the required bandwidth, the data flow is transmitted through the single link. In addition, a recovery operation of the original sequence of the packets is not performed. In this way, the throughput can be increased.

Communication System

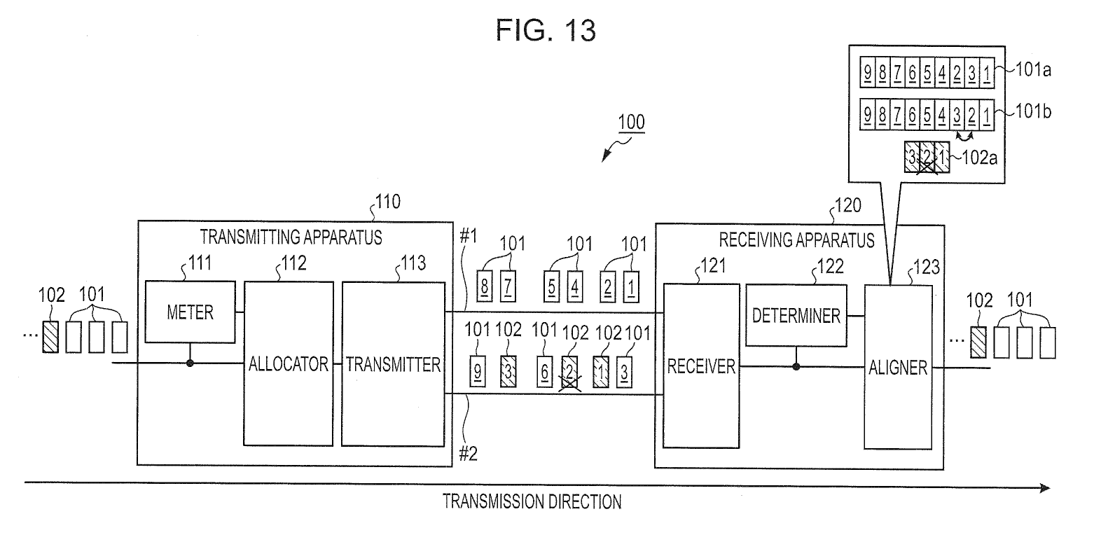

FIG. 13 illustrates a communication system according to a second exemplary embodiment. In FIG. 13, the same reference numerals are used for identical or similar components as used in FIG. 2, and descriptions of the components are not repeated. As illustrated in FIG. 13, according to the second exemplary embodiment, the transmitting apparatus 110 adds a sequence number to each of the packets 102 of the data flow 2 that is transmitted through a single link in addition to each of the packets 101 of the data flow 1 that is transmitted through a parallel links. In this way, the transmitting apparatus 110 need not take into account allocation for data flows in order to add a sequence number. Thus, the processing can be simplified.

Let the traffic volumes of the data flows 1 and 2 and the transmission speeds of the aggregation links #1 and #2 be the same as those in FIG. 2. The transmitter 113 sets a flag (flag information) for each of the packets of a data flow allocated to a parallel links. However, the transmitter 113 does not set a flag for each of the packets of a data flow allocated to a single link. In this example, the transmitter 113 sets a flag for each of the packets 101 of the data flow 1. However, the transmitter 113 does not set a flag for each of the packets 102 of the data flow 2. In FIG. 13, the underline of the sequence number of each of the packets 101 indicates that a flag is set for the packet.

The determiner 122 of the receiving apparatus 120 determines whether the data flow of a packet is transmitted through a parallel links or a single link by determining whether a flag is set for the packet received by the receiver 121. As in FIG. 2, the aligner 123 recovers the original sequence of the packets 101 of the data flow 1 based on the sequence numbers. However, the receiving apparatus 120 does not recover the original sequence of the packets 102 of the data flow 2 although the packets 102 have the sequence numbers, since the original sequence can be preserved during transmission from the transmitting apparatus 110 to the receiving apparatus 120. Thereafter, the receiving apparatus 120 outputs the packets 102.

In the example illustrated in FIG. 13, one of the packets 102 of the data flow 2 that is transmitted through the aggregation link #2 and that has the sequence number “2” is not successfully received by the receiving apparatus 120 and becomes a lost packet. A packet sequence 102a includes the packets of the data flow 2 received by the receiving apparatus 120. In this case, the packets 102 of the data flow 2 are received by the receiver 121 so that the packet having the sequence number “1” is received first and, subsequently, the packet having the sequence number “3” is received. Thus, one of the packets 102 having the sequence number “2” is missing.

Even in such a case, the aligner 123 outputs the packets 102 having the sequence numbers “1” and “3” without recovering the original sequence of the packets 102 of the data flow 2 immediately after the aligner 123 receives the packets. In this way, a packet transmission delay caused by waiting for receiving one of the packets 102 having the sequence number “2” until a timeout occurs can be prevented.

In order to set a flag for a packet, for example, when an option header for a sequence number is inserted into the packet, one bit of the option header may be used as the flag. However, a technique for setting the flag is not limited thereto. Any other method can be employed for setting the flag.

Example of Application of Transmitting Apparatus and Receiving Apparatus

Examples of application of the transmitting apparatus 110 and the receiving apparatus 120 are the same as those of the transfer apparatus 300 and the transfer apparatuses 400A and 400B illustrated in FIGS. 3 and 4.

Processing Performed by Transfer Apparatus on Transmitter Side

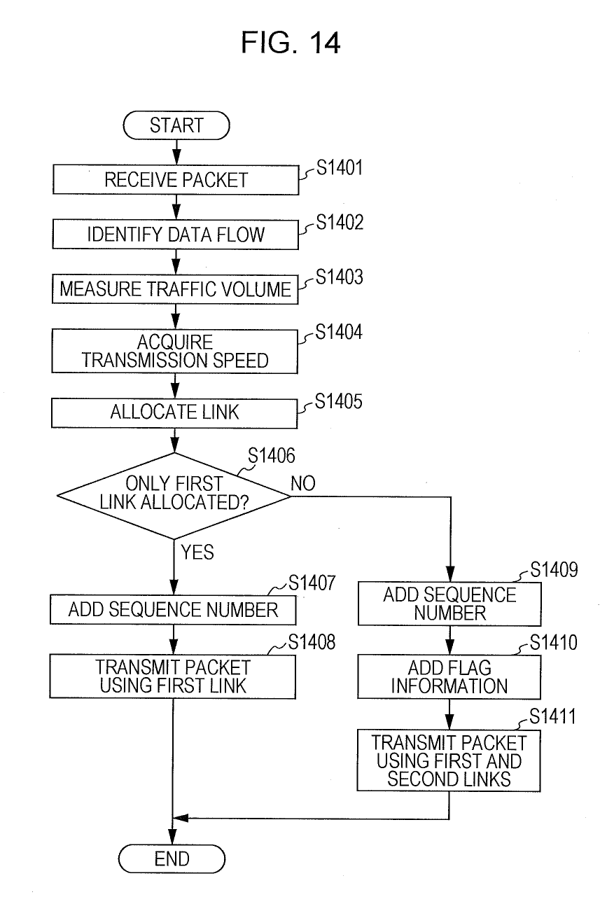

FIG. 14 illustrates an example of a method for the processing performed by the transfer apparatus on the transmitter side according to the second exemplary embodiment. According to the second exemplary embodiment, the transfer apparatus 400A on the transmitter side performs processing illustrated in FIG. 7 and repeatedly performs, for example, operations illustrated in FIG. 14. Operations S1401 to S1406 illustrated in FIG. 14 are the same as operations S501 to S506 illustrated in FIG. 5, respectively. If, in operation S1406, only the first link is allocated (“Yes” in operation S1406), the transmitting processor 327 adds a sequence number to each of the packets of the data flow (operation S1407). However, if, in operation S1406, the first and second links are allocated (“No” in operation S1406), the transmitting processor 327 adds a sequence number to the packet of the data flow (operation S1409) and attaches the flag information (operation S1410).

Note that if the message processor 325 of the transfer apparatus 400A sends, to the transfer apparatus 400B on the receiver side, a control message indicating that the first and second link are allocated to the data flow, the transmitting processor 327 need not add the flag information (operation S1410).

Operations S1408, S1409, and S1411 illustrated in FIG. 14 are the same as operations S507 to S509 illustrated in FIG. 5, respectively. As described above, according to the second exemplary embodiment, even when only the first link is allocated, the transfer apparatus 400A on the transmitter side adds a sequence number to each of the packets of the data flow.

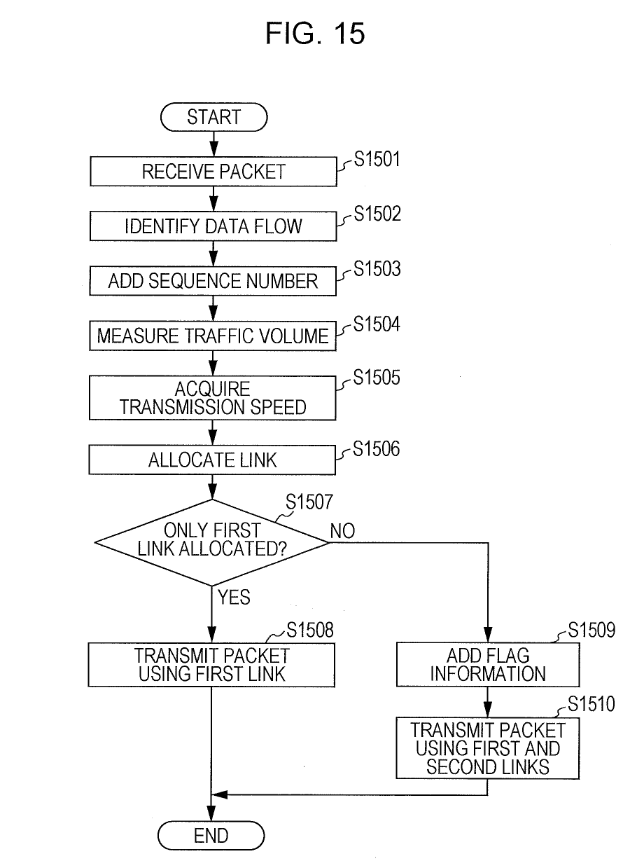

FIG. 15 illustrates another example of a method for the processing performed by the transfer apparatus on the transmitter side according to the second exemplary embodiment. According to the second exemplary embodiment, the transfer apparatus 400A on the transmitter side performs the processing illustrated in FIG. 7 and may repeatedly perform, for example, operations illustrated in FIG. 15. Operations S1501 and S1502 illustrated in FIG. 15 are the same as operations S1401 and S1402 illustrated in FIG. 14, respectively. After operation S1502 is performed, the transmitting processor 327 adds a sequence number to each of the packets of the data flow (operation S1503). Operations S1504 to S1507 illustrated in FIG. 15 are the same as operations S1403 to S1406 illustrated in FIG. 14, respectively.

If, in operation S1507, only the first link is allocated (“Yes” in operation S1507), the processing performed by the transfer apparatus 400A proceeds to operation S1508. However, if, in operation S1507, the first and second links are allocated (“No” in operation S1507), the processing performed by the transfer apparatus 400A proceeds to operation S1509, where the transmitting processor 327 adds the flag information to the packet of the data flow.

Note that if the message processor 325 of the transfer apparatus 400A sends, to the transfer apparatus 400B on the receiver side, a control message indicating that the first and second link are allocated to the data flow, the transmitting processor 327 need not add the flag information (operation S1509). Operations S1508 and S1510 illustrated in FIG. 15 are the same as operations S1408 and S1410 illustrated in FIG. 14, respectively. As described above, the transfer apparatus 400A may add a sequence number to a packet of the data flow before a link is allocated to the data flow in operation S1506.

Processing Performed by Transfer Apparatus on Receiver Side

Example 1 of Processing. Performed by Transfer Apparatus on Receiver Side

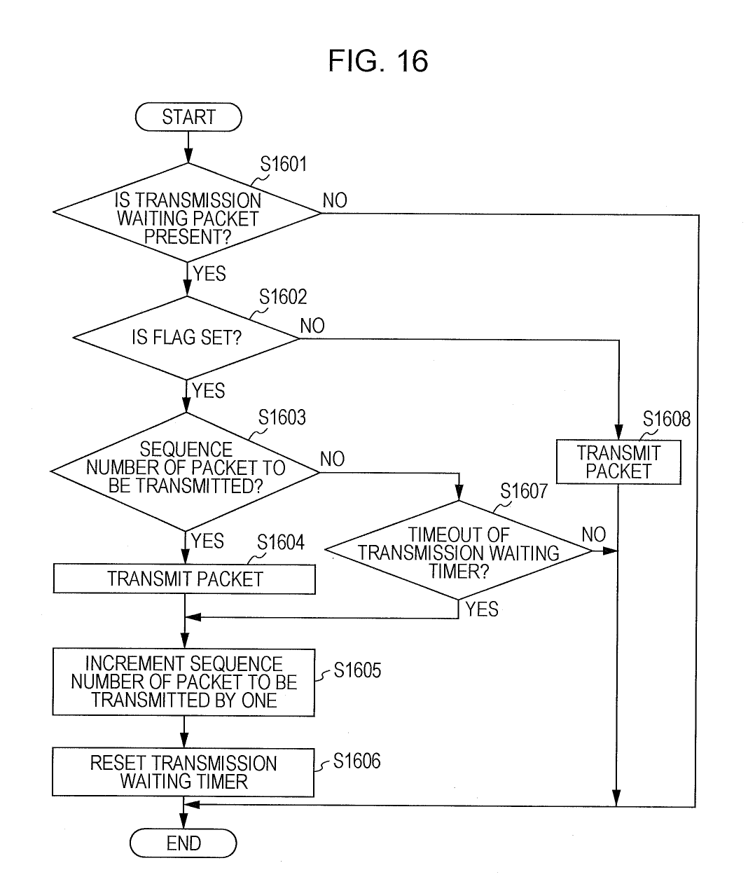

FIG. 16 illustrates a first example of a method for the processing performed by the transfer apparatus on the receiver side according to the second exemplary embodiment. The transmitting processor 327 of the transfer apparatus 400B on the receiver side may perform, for example, the processing illustrated in FIG. 16 in addition to the processing illustrated in FIG. 7. Operations S1601 to S1608 illustrated in FIG. 16 are the same as operations S801 and S808 illustrated in FIG. 8, respectively.

However, in operation S1602, the transmitting processor 327 determines whether the transfer apparatus 400A sets a flag for the packet (operation S1602). If a flag is not set for the packet (“No” in operation S1602), the processing performed by the transfer apparatus 400B proceeds to operation S1608. However, if a flag is set for the packet (“Yes” in operation S1602), the processing performed by the transfer apparatus 400B proceeds to operation S1603.

In this way, according to the second exemplary embodiment, the transmitting processor 327 determines whether the data flow is transmitted through a parallel links or a single link by determining whether a flag is set for the packet by the transfer apparatus 400A.

Example 2 of Processing Performed by Transfer Apparatus on Receiver Side

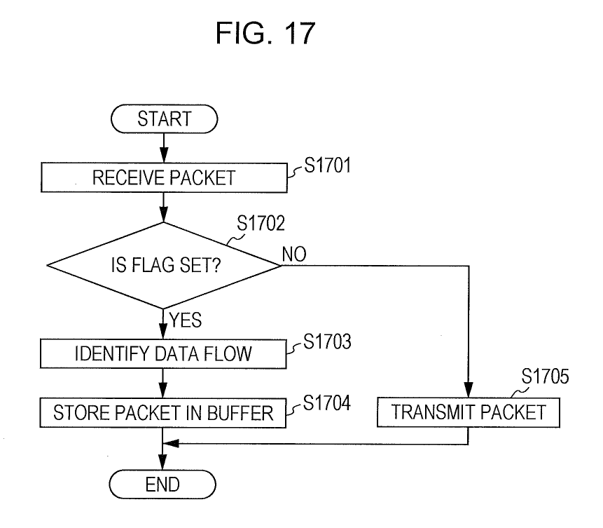

FIG. 17 illustrates a second example of a method for the processing performed by the transfer apparatus on the receiver side according to the second exemplary embodiment. The transfer apparatus 400B may perform, for example, the processing illustrated in FIG. 17. Operations S1701 to S1705 illustrated in FIG. 17 are the same as operations S901 to S905 illustrated in FIG. 9, respectively. However, in operation S1702, the receiving processor 328 determines whether the packet received in operation S1701 has a flag set therefor (operation S1702).

If, in operation S1702, a flag is set (“Yes” in operation S1702), the processing performed by the transfer apparatus 400B proceeds to operation S1703. However, if in operation S1702, a flag is not set (“No” in operation S1702), the processing performed by the transfer apparatus 400B proceeds to operation S1705. In this way, if the data flow of the received packet is transmitted through a single link, the packet may be output without performing identification of the data flow and a recovery operation of the original sequence of the packets.

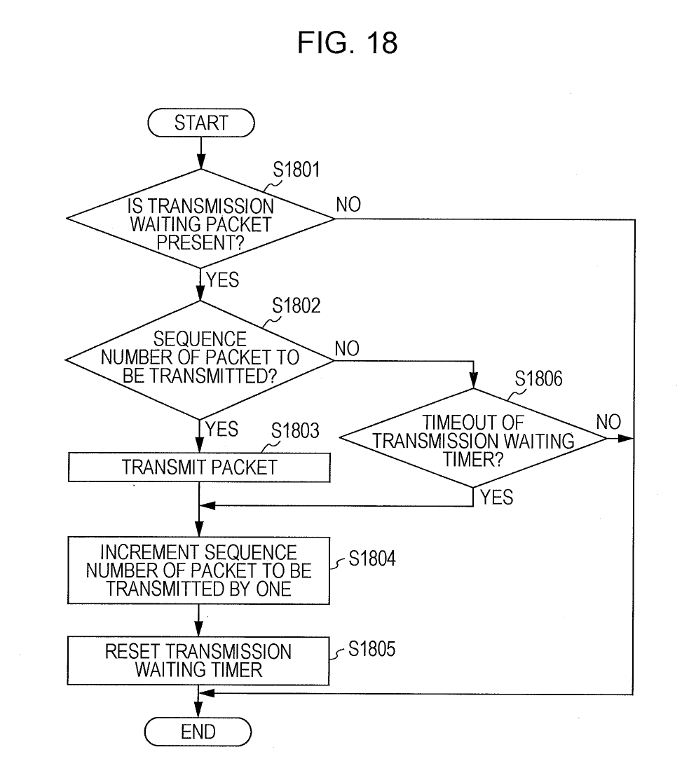

FIG. 18 illustrates the second example of a method for the processing performed by the transfer apparatus on the receiver side according to the second exemplary embodiment. When performing the processing illustrated in FIG. 17, the transfer apparatus 400B may perform, for example, the processing described below on each of the data flows. The transmitting processor 327 determines whether a transmission waiting packet is present in a buffer for the target data flow (operation S1801). If a transmission waiting packet is not present in the buffer for the target data flow (“No” in operation S1801), the transfer apparatus 400B completes the series of processes.

However, if, in operation S1801, a transmission waiting packet is present in the buffer for the target data flow (“Yes” in operation S1801), the processing performed by the transfer apparatus 400B proceeds to operation S1802. Operations S1802 to S1806 are the same as operations S1603 to S1607 illustrated in FIG. 16, respectively. That is, when the processing illustrated in FIG. 17 is performed, the packets stored in the buffer are packets of the data flow transmitted through a parallel links. Accordingly, the transfer apparatus 400B recovers the original sequence of the packets stored in the buffer.

As illustrated in FIGS. 17 and 18, the transfer apparatus 400B determines whether the received packet has a flag set therefore first. If a flag is set, the transfer apparatus 400B performs identification of the data flow and a recovery operation of the original sequence of the packets. However, if the received packet has no flag set therefor, the transfer apparatus 400B directly transmits the received packet.

According to the second exemplary embodiment, the transmitting processor 327 of the transfer apparatus 400B may perform the processing illustrated in FIG. 11 in addition to the processing illustrated in FIG. 7.

As described above, in the communication system 100 according to the second exemplary embodiment, the transmitting apparatus 110 sets flag information indicating whether the data flow is transmitted through a parallel links or a single link for each of the packet of the data flow. Thus, the receiving apparatus 120 can determine whether the data flow is transmitted through a parallel links or a single link based on the flag information set for the received packet.

In such a case, the transmitting apparatus 110 may add a sequence number to each of the packets when the data flow is transmitted through a parallel links and when the data flow is transmitted through a single link. In this way, the transmitting apparatus 110 need not take into account allocation of data flows in order to add a sequence number. Thus, the processing performed by the transmitting apparatus 110 can be simplified.

### Third Exemplary Embodiment

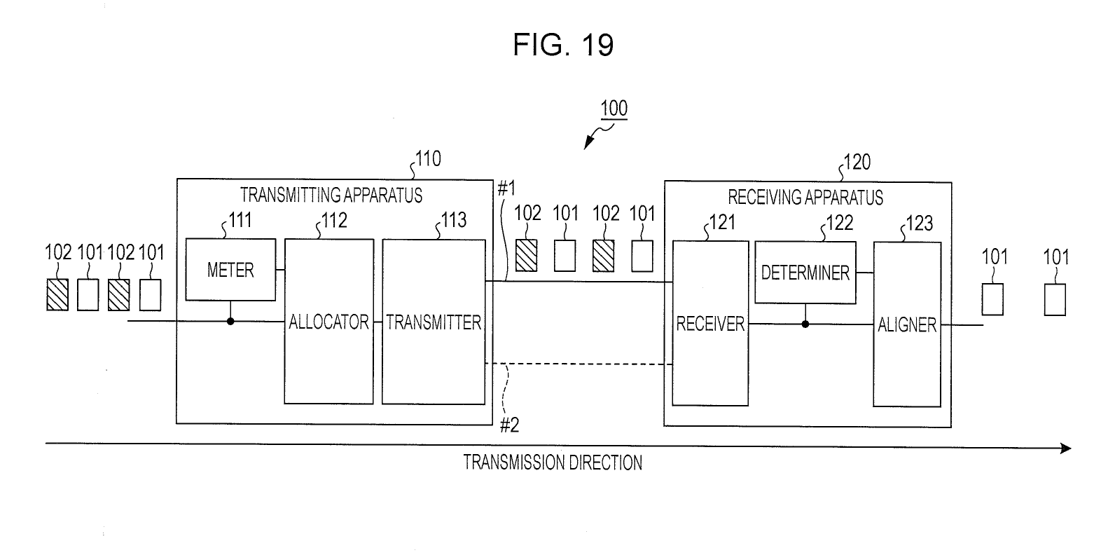

FIG. 19 illustrates a communication system according to a third exemplary embodiment. In FIG. 19, the same reference numerals are used for identical or similar components as used in FIG. 1, and descriptions of the components are not repeated. In the example illustrated in FIG. 19, the traffic volume of each of the data flows 1 and 2 is 30 Mbps. In addition, the transmission speed of each of the aggregation links #1 and #2 is 100 Mbps.

In this example, even when both data flows 1 and 2 are transmitted through one of the aggregation links #1 and #2, the bandwidth is sufficient. In such a case, for example, the transmitting apparatus 110 allocates the aggregation link #1 serving as the first link to both data flows 1 and 2. The second link needs not be allocated to either one of the data flows. At that time, the aggregation link #2 is not used as the first or second link of either one of the data flows.

In this example, the transmitter 113 of the transmitting apparatus 110 temporarily disables the operation mode of the aggregation link #2. For example, if each of the aggregation links #1 and #2 is a wireless link, the transmitter 113 stops outputting a wireless signal or intermittently outputs the wireless signal. In this way, the power consumption can be reduced. In addition, if a data flow is allocated to even an aggregation link that is disabled by the allocator 112, the transmitter 113 enables the disabled aggregation link.

As described above, the communication system 100 allocates a data flow to a parallel links or a single link based on the traffic volume of the data flow and the transmission speed of each of the links. Accordingly, a link that is not allocated to any one of the data flows may appear. In such a case, the link that is not allocated to any one of the data flows is temporarily stopped. In this way, the power consumption of the transmitting apparatus 110 can be reduced.

Example of Application of Transmitting Apparatus and Receiving Apparatus

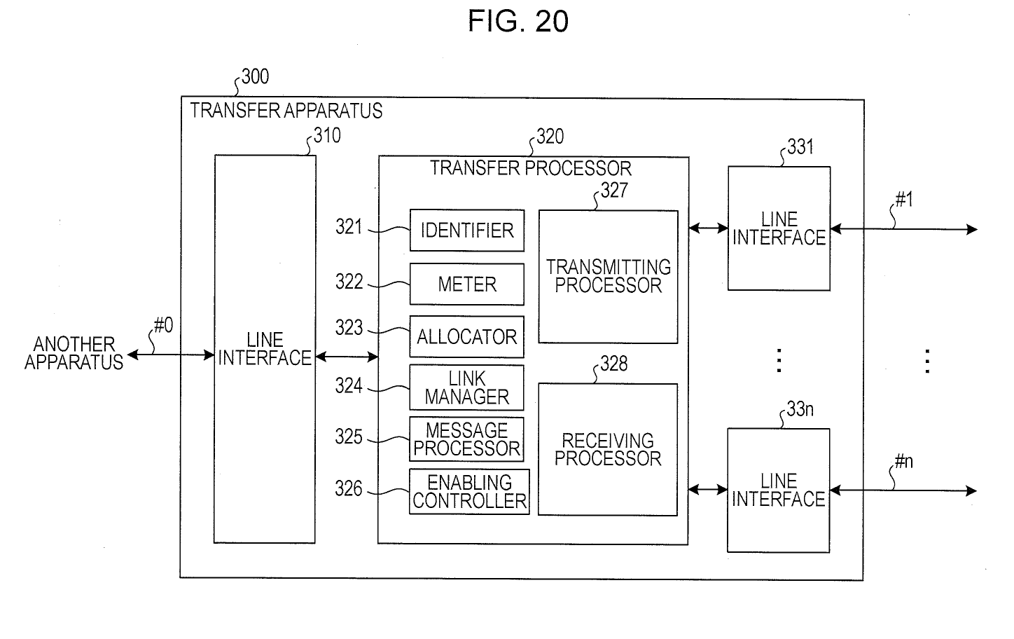

FIG. 20 illustrates an example of application of a transmitting apparatus and a receiving apparatus according to the third exemplary embodiment. In FIG. 20, the same reference numerals are used for identical or similar components as used in FIG. 3, and descriptions of the components are not repeated. The transfer apparatus 300 illustrated in FIG. 20 is a transfer apparatus to which the transmitting apparatus 110 and the receiving apparatus 120 illustrated in FIG. 19 are applied. The transfer apparatus 300 has a configuration that is similar to the configuration illustrated in FIG. 3 and additionally includes an enabling controller 326. The enabling controller 326 may be formed from a circuit. Alternatively, the enabling controller 326 may be formed from one or more DSPs and/or one or more FPGAs.

Among the line interfaces 331 to 33n, the enabling controller 326 temporarily disables the line interface corresponding to the aggregation link to which any one of the data flows is not allocated based on the result of allocation performed by the allocator 323. More specifically, the enabling controller 326 stops outputting a wireless signal from the circuit interface or intermittently outputs the wireless signal. In addition, among the disabled circuit interfaces, the enabling controller 326 enables the circuit interface to which a data flow is allocated based on the result of allocation performed by the allocator 323.

Processing Performed by Transfer Apparatus on Transmitter Side

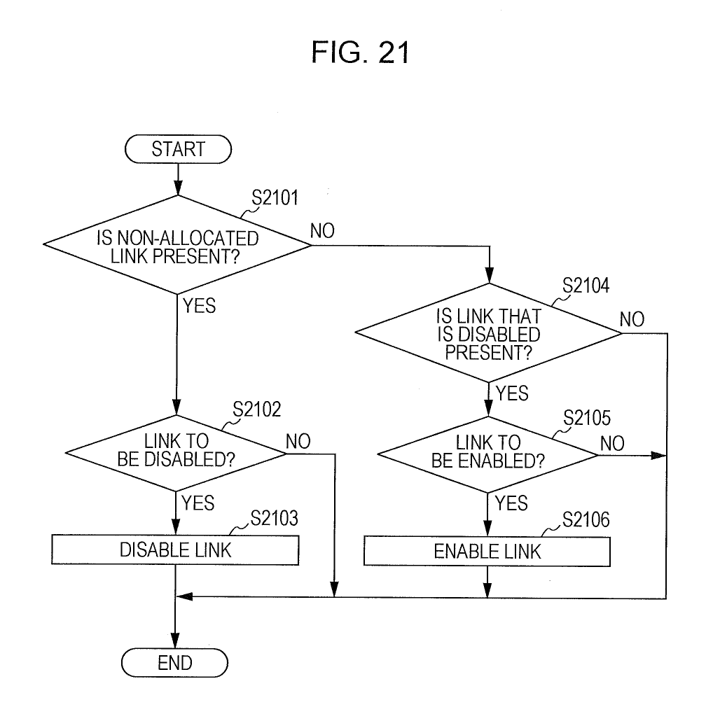

FIG. 21 illustrates an example of a method for the processing performed by an enabling controller according to the third exemplary embodiment. According to the third exemplary embodiment, the enabling controller 326 of the transfer apparatus 400A performs, for example, the operations illustrated in FIG. 21 in addition to the above-described process. The operations illustrated in FIG. 21 may be periodically performed independently from the packet transmitting process. Alternatively, the operations illustrated in FIG. 21 may be performed each time the link allocation state is altered in accordance with, for example, the link allocation process illustrated in FIG. 6.

The enabling controller 326 determines whether among the enabled aggregation links, a link to which any one of the data flows is not allocated is present based on the result of allocation performed by the allocator 323 (operation S2101). If a link to which any one of the data flows is not allocated is present (“Yes” in operation S2101), the enabling controller 326 determines whether the link to which any one of the data flows is not allocated is disabled (operation S2102).

For example, in operation S2102, the enabling controller 326 determines that the link to which any one of the data flow is not allocated is always disabled. Alternatively, if, among the enabled links, the available bandwidth of a link having the maximum available bandwidth is less than a threshold value, the enabling controller 326 may determine that the link is not disabled. However, if the available bandwidth of the enabled link having the maximum available bandwidth is greater than or equal to the threshold value, the enabling controller 326 may determine that the link is disabled.

Alternatively, if the sum of the available bandwidths of the enabled links is less than a threshold value, the enabling controller 326 may determine that the link is not disabled. However, if the sum of the available bandwidths of the enabled links is greater than or equal to the threshold value, the enabling controller 326 may determine that the link is disabled. Still alternatively, if the minimum usage ratio among the usage ratios of the enabled links is greater than a threshold value, the enabling controller 326 may determine that the link is not disabled. However, if the minimum usage ratio among the usage ratios of the enabled links is less than or equal to the threshold value, the enabling controller 326 may determine that the link is disabled.

Yet still alternatively, if the value obtained by dividing the sum of the traffic volumes of the enabled links by the sum of the transmission speeds of the enabled links (i.e., the overall usage ratio) is greater than a threshold value, the enabling controller 326 may determine that the link is not disabled. However, if the overall usage ratio is less than or equal to the threshold value, the enabling controller 326 may determine that the link is disabled.

If, in operation S2102, it is determined that a link to which any one of the data flows is not allocated is not disabled (“No” in operation S2102), the enabling controller 326 completes the series of processes. However, if it is determined that a link to which any one of the data flows is not allocated is disabled (“Yes” in operation S2102), the enabling controller 326 disables the link to which any one of the data flows is not allocated (operation S2103). Thereafter, the enabling controller 326 completes the series of processes.

However, if, in operation S2101, a link to which any one of the data flows is not allocated is absent (“No” in operation S2101), the enabling controller 326 determines whether a link that is disabled is present (operation S2104). If, in operation S2104, a link that is disabled is not present (“No” in operation S2104), the enabling controller 326 completes the series of processes. However, if a link that is disabled is present (“Yes” in operation S2104), the enabling controller 326 determines whether the link that is disabled is enabled (operation S2105).

For example, if, in operation S2105, the available bandwidth of the link having the maximum available bandwidth among the enabled links is greater than a threshold value, the enabling controller 326 may determine that the link is not enabled. However, if, in operation S2105, the available bandwidth of the link having the maximum available bandwidth among the enabled links is less than or equal to the threshold value, the enabling controller 326 may determine that the link is enabled.

Alternatively, if the sum of the available bandwidths of the enabled links is greater than a threshold value, the enabling controller 326 may determine that the link is not enabled. However, if the sum of the available bandwidths of the enabled links is less than or equal to the threshold value, the enabling controller 326 may determine that the link is enabled. Still alternatively, if the minimum usage ratio among the usage ratios of the enabled links is less than a threshold value, the enabling controller 326 may determine that the link is not enabled. However, if the minimum usage ratio among the usage ratios of the enabled links is greater than or equal to the threshold value, the enabling controller 326 may determine that the link is enabled.

Yet still alternatively, if the value obtained by dividing the sum of the traffic volumes of the enabled links by the sum of the transmission speeds of the enabled links (i.e., the overall usage ratio) is less than a threshold value, the enabling controller 326 may determine that the link is not enabled. However, if the overall usage ratio is greater than or equal to the threshold value, the enabling controller 326 may determine that the link is enabled.

If, in operation S2105, it is determined that the link is not enabled (“No” in operation S2105), the enabling controller 326 completes the series of processes. However, if it is determined that the link that is disabled is enabled (“Yes” in operation S2105), the enabling controller 326 enables the link that is disabled (operation S2106). Thereafter, the enabling controller 326 completes the series of processes. As described above, in the communication system 100 according to the third exemplary embodiment, among the links between the transmitting apparatus 110 and the receiving apparatus 120, the transmitting apparatus 110 disables a link to which any one of the data flows is not allocated. In this way, the power consumed by the transmitting apparatus 110 can be reduced.

Examples of Application of Transfer Apparatuses of Exemplary Embodiments

Examples of application of the transfer apparatuses according to the above-described exemplary embodiments are described next.

Application of Transfer Apparatus to Backbone Line between Base Station of Wireless Network and Core Network

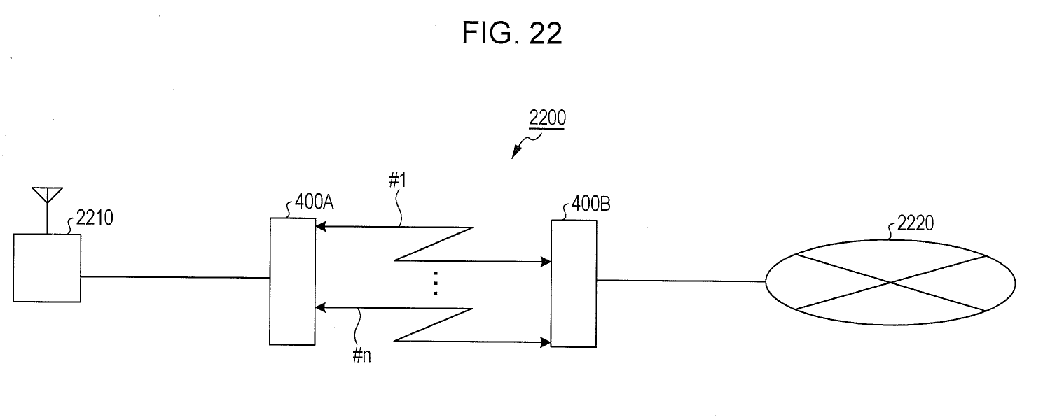

FIG. 22 illustrates a first example of a communication system to which the transfer apparatus is applied. In FIG. 22, the same reference numerals are used for identical or similar components as used in FIG. 4, and descriptions of the components are not repeated. As illustrated in FIG. 22, a communication system 2200 includes a wireless base station 2210, transfer apparatuses 400A and 400B, and a wireless system core network 2220.

The transfer apparatus 400A and the transfer apparatus 400B transfer the data flows communicated between the wireless base station 2210 and the wireless system core network 2220 using aggregation of the aggregation links #1 to #n. In this way, the transfer apparatus 400A and the transfer apparatus 400B can be applied to the backbone line between the wireless base station 2210 and the wireless system core network 2220 of the communication system 2200.

Application of Transfer Apparatus to Communication Link Portions of Wireless Base Station and Wireless Terminal

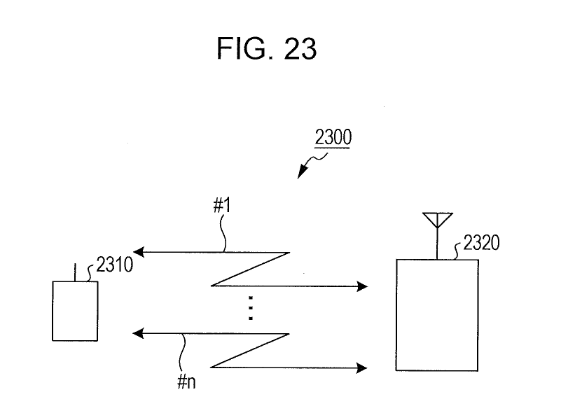

FIG. 23 illustrates a second example of the communication system to which the transfer apparatus is applied. In FIG. 23, the same reference numerals are used for identical or similar components as used in FIG. 4, and descriptions of the components are not repeated. As illustrated in FIG. 23, a communication system 2300 includes a wireless terminal 2310 and a wireless base station 2320. The wireless terminal 2310 and the wireless base station 2320 perform multi-carrier communication in which a data flow is communicated therebetween using aggregation of the aggregation links #1 to #n of carrier frequencies f1 to fn.

In order to use the plurality of carrier frequencies f1 to fn in multi-carrier communication at the same time, the wireless links of the carrier frequencies f1 to fn can be used as the aggregation links #1 to #n, respectively. The transfer apparatus 400A and the transfer apparatus 400B illustrated in FIG. 4 can be applied to the wireless terminal 2310 and the wireless base station 2320, respectively. In this way, the transfer apparatus 400A and the transfer apparatus 400B can be applied to the communication link portions of the wireless base station 2320 and the wireless terminal 2310 of the communication system 2300.

In this way, according to the above-described communication system, communication method, receiving apparatus, and transmitting apparatus, the throughput can be improved. Note that while the above exemplary embodiments have been described with reference to the configuration for transmitting a plurality of data flows, a configuration for transmitting a single data flow may be employed. In addition, according to the above-described communication system, communication method, receiving apparatus, and transmitting apparatus, the throughput can be advantageously increased.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions has(have) been described in detail, it should be understood that the various changes, substitutions, and alterations could be made hereto without departing from the spirit and scope of the invention.

What is claimed is:

1. A communication system comprising:
a transmitter that transmits a data flow through a single link or a parallel links; and
a receiver that receives packets of the data flow, when the data flow of the received packets is transmitted through the parallel links, the received packets are aligned in order and output, and when the data flow of the received packets is transmitted through the single link, the received packets are output in a received sequence.

2. The communication system according to claim 1, wherein
when the transmitter transmits the data flow through the parallel links, sequence information indicating a sequence number is added in each packet; and
when the transmitter transmits the data flow through the single link, sequence information indicating a sequence number is not added in each packet.

3. The communication system according to claim 2, wherein
the receiver determines which the data flow is transmitted through the parallel links or the single link, based on the sequence information is added in each received packet.

4. The communication system according to claim 1, wherein
the transmitter sets flag information in packets of the data flow, indicating which the data flow is transmitted through the single link or the parallel links,
the receiver determines which the data flow is transmitted through the single link or the parallel links, based on the flag information set in the packets of the data flow.

5. The communication system according to claim 1, wherein
the transmitter transmits to the receiver control information indicating which the single link or the parallel links is transmitted, and
the receiver determines which the data flow is transmitted through the parallel links or the single link, based on the control information transmitted by the transmitter.

6. The communication system according to claim 1, wherein
the transmitter includes a traffic meter that measures amount of traffic, and transmits the data flow to one of the parallel links or the parallel links, based on the amount of the traffic.

7. The communication system according to claim 6, wherein
the transmitter obtains a transmission speed of each link of the parallel links, and transmits the data flow to one of the parallel links or the parallel links, based on the link speed and the amount of traffic.

8. The communication system according to claim 7, wherein
the transmitter obtains a utilization of each link or an unused bandwidth, and transmits the data flow to one of the parallel links or the parallel links, based on the utilization of each link or the unused bandwidth of each link.

9. The communication system according to claim 1, wherein
the transmitter makes a link an invalid status when the link has not been assigned for transmitting the data flow.

10. The communication system according to claim 1, wherein
the transmitter transmits the data flow through one or more links among radio links between the transmitter and the receiver.

11. The communication system according to claim 1, wherein
the transmitter transmits a plurality of data flows, and the receiver separately receives the plurality of data flows, respectively.

12. Communication method comprising:
transmitting a data flow through a single or a parallel links;
receiving packets of the data flow transmitted; and
outputting packets of the data flow in an aligned order when the data flow is received through the parallel links, or outputting the packets of the data flow in a received order when the data flow is received through the single link.

13. A receiving apparatus:
a receiver configured to receive packets of a data flow through a single link or a parallel links;
a determiner configured to determine that the packets of the data flow received by the receiver are transmitted through the single link or the parallel links; and
an aligner configured to output packets of the data flow in an aligned order when the data flow of the received packets is transmitted through the parallel links, and to output the packet of the data in a received order when the data flow of the received packets is transmitted through the single link.

14. A transmission apparatus comprising:
a traffic meter that measures amount of traffic;
a traffic allocator that allocates the data flow to one of the parallel links or the parallel links, based on the amount of the traffic; and
a transmitter that transmits the data flow to the receiver through at least one of the plurality of links, based on an allocation result by the traffic allocator.
